(19) United States
(12) Patent Application Publication
(10) Pub. No.: US 2009/0259683 A1
(43) Pub. Date: Oct. 15, 2009

(54) SYSTEM AND METHOD FOR BUSINESS OBJECT MODELING

(75) Inventor: Venkataesh V. Murty, Allen, TX (US)

Correspondence Address: WOLF GREENFIELD & SACKS, P.C., 600 ATLANTIC AVENUE, BOSTON, MA, 02210-2206, US

(73) Assignee: FIBERLINK COMMUNICATIONS CORPORATION, Blue Bell, PA (US)

(21) Appl. No.: 12/102,403

(22) Filed: Apr. 14, 2008

(51) Int. Cl. G06F 17/30

(52) U.S. Cl. 707/103 R; 707/100; 707/3; 707/E17.055; 707/E17.048; 707/E17.014

(57) ABSTRACT

An enterprise information system consists of two fundamental components—the data and the business logic. Relational databases can provide a stable, clear and robust implementation of transactions with ACID properties and a declarative query language (SQL) for managing data and are at the core of modern enterprise computing. But modern programming languages like Java—a compiled language, and Javascript—a scriptable language, provide a much better environment for implementing complex business logic. Object Relational Mapping (ORM) tools provide a bridge between the relational environment and the object environment, so that data can be persisted in a relational data model and business logic can be encoded using objects. An extension to the standard ORM is provided to allow an application written in an object oriented language to deal with the information it manipulates in terms of objects, rather than in terms of database-specific concepts such as rows, columns and tables.

### TECHNICAL FIELD

Aspects and features described herein relate to extensions to object-relational mapping (ORM) methods for enterprise systems that enable data model extensions and easy addition of business logic by an enterprise.

### BACKGROUND

In today's information-driven economy, the ability of an enterprise to efficiently store, update, and use information can be critical to the enterprise's ability to serve its customers and compete in the economy.

An entity such as a business enterprise can model a concept of an entity relating to that enterprise and use such modeling information to maintain and use information relating to that entity. Some examples are of entities that can be modeled by an enterprise include user, bill of materials etc. An enterprise can maintain and model data relating to these entities in either a relational programming environment or in an object-oriented environment such as the commonly used Java environment. In a relational system, data is maintained in one or more data tables, where each row refers to an instance of the entity. In an object system, an entity concept is modeled using classes, where each instance of the class—called an object—refers to an instance of the entity, with characteristics of those objects being known as “attributes” of that object. In order to bridge the two systems, object-relational modeling (ORM) techniques are used to enable an enterprise to use data maintained in relational databases in an object-oriented environment. One popular ORM software is the open source object-relational mapping software known as “Hibernate.”

The ability to work with data in both a relational and object-oriented system can be very important to an enterprise's business. For example, a provider of software as a service (“SaaS provider”) may have to install an enterprise system and provide service to multiple customers, where each customer is an enterprise in its own right. In such an environment, the system should be able to let each customer define their own extensions to the model, add their own business logic and define their own rules for attribute value computations. Ideally, the system should let each customer manage the extensions and business logic on their own, without affecting other customers in functionality and performance.

To this end, an enterprise may make a large investment in an enterprise data management system that meet almost all its objectives except a few. To meet the last mile of its objectives may require a small extension to the data model, like having an additional attribute for an entity with some additional business logic. The usual solution is for the enterprise to continue with the deficient product or request the creator of the product to add additional attributes to the entity as part of the next release. Such requests may not be appropriate in a general setting, i.e. the request is very specific to the internal running of the requesting enterprise.

In many cases, the enterprise data management system has to work along with other systems that are already installed and in use. For a new enterprise system to efficiently blend into an existing enterprise ecosystem, the two systems must be integrated. Such integration often is accomplished by using daily or hourly computer synchronization tasks, which, however, represent costly and inefficient use of the enterprise's computing resources. For example, the concept of “user” may exist in a user directory like Microsoft Corporation's Active Directory product, the concept of “bill of materials” (“BOM”) may exist in an enterprise resource planning (“ERP”) system like SAP™, and the new enterprise system may require the user information, the BOM information, or both.

One possible scenario in this regard is where one computer job synchronizes changes to the enterprise's user directory, often known as an “Active Directory,” to the new enterprise system, and another job synchronizes the BOM information from the new system to the existing ERP system. Such synchronization is essential; if it is not done, people in the enterprise would have to manage the same concept in multiple systems—which is not only inefficient, but more importantly, could result in the presence of inconsistent data in the different systems. Usually, synchronization of data between multiple systems satisfies most of the data requirements. However, synchronization often does not fully cover all attributes of the enterprise's data. For example, the new system may have to enable a workflow based on the user's role, e.g. planner. One conventional solution to this situation has been to add an additional attribute in the Active Directory. This creates a duplication of the role concept that already existed in Active Directory but did not map exactly to the concept of role in the new enterprise system.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

Aspects herein relate to a system and method to permit an enterprise to define one or more additional “extension” attributes of an its entities in addition to the core attributes already defined in the enterprise's database and to use object-relational mapping (ORM) techniques to determine the value of such extension attributes. Other aspects relate to a system and method to permit the enterprise to develop one set of business logic to access and use both the core and extension attributes without having to distinguish between the two. Other aspects relate a system and method of synchronizing an enterprise's data to permit the value of an attribute to be derived based on other attributes of the user, so that if a value of one attribute changes, the values of the other attribute follows suit without the need to independently change that value. Still other aspects relate to a system and method for use of a query processor or other mechanism to permit an enterprise to use object-oriented queries to obtain information regarding data maintained by the enterprise in relational data tables without having to know the data structure or construct cumbersome and complex relational data queries and distinguishing between core and extension attributes. Still other aspects relate to a system and method to enable a customer in an SaaS environment to add extension attributes and define business rules without affecting another customer in a multi-customer environment.

### BRIEF DESCRIPTION OF DRAWINGS

FIG. 1 depicts an exemplary relational table representing a concept of “users” modeled by an entity.

FIG. 2 depicts an exemplary software code sequence representing a “Plain Old Java Object (POJO)” for the User class of object.

FIG. 3 depicts an exemplary software code sequence representing a possible implementation of the class Address.

FIG. 4 depicts an exemplary Hibernate XML software code sequence representing file mapping of a Java object to records in a relational table.

FIG. 5 depicts an exemplary software code sequence representing a class definition for an entity type Nationality.

FIG. 6 depicts an exemplary Hibernate XML software code sequence for an entity type Nationality.

FIG. 7 depicts an exemplary software code sequence depicting a Plain Old Java Object (POJO) showing an entity property that maps to a foreign key.

FIG. 8 depicts an exemplary set of relational database tables comprising a USER table with a foreign key NATIONALITY_ID to NATIONALITY table.

FIG. 9 depicts an exemplary Hibernate XML software code sequence representing a unidirectional many-to-one relationship.

FIG. 10 depicts an exemplary software code sequence for showing an attribute comprising a list of fundamental type.

FIG. 11 depicts an exemplary set of relational database tables comprising a USER table and a USER_NICKNAMES table.

FIG. 12 depicts an exemplary Hibernate XML software code sequence representing USER_NICKNAMES as an attribute of “collection” type.

FIG. 13 depicts an exemplary relational database vertical table storing attribute values.

FIG. 14 depicts an exemplary ATTRIBUTE table containing information of extension attributes in accordance with aspects described herein.

FIGS. 15A and 15B depict exemplary relational database tables showing values for the extension attribute visited_countries for instances of class User.

FIG. 16 is a block diagram depicting components of an extendable Object Relational Mapping.

FIG. 17 depicts an exemplary software code sequence depicting a Plain Old Java Object (POJO) showing object storage of extension attribute values.

FIG. 18 depicts an exemplary Hibernate XML software code sequence representing use of a parent-child relationship to manage extension attribute values.

FIG. 19 depicts an exemplary software code sequence depicting a general flow of a “get” method to obtain a value of an attribute.

FIG. 20 depicts an exemplary software code sequence depicting a general flow of a “set” method to obtain a value of an attribute.

FIG. 21 is a block diagram depicting an exemplary flow of user data to a Billing System from a User Directory.

FIGS. 22A-22D depicts exemplary relational database tables for use in determining rule-based attribute values in accordance with one or more aspects described herein.

FIG. 23 depicts an exemplary software code sequence representing a Java object with a rule-based flag in accordance with one or more aspects described herein.

FIG. 24 depicts an exemplary software code sequence representing XML mapping to capture a rule-based bit in accordance with one or more aspects described herein.

FIG. 25 depicts an exemplary relational database table having a hierarchical representation of Organizations in accordance with one or more aspects described herein.

FIG. 26 is a pictorial representation of Organizations as shown in FIG. 26.

FIG. 27 depicts an exemplary software code sequence representing an organization context in accordance with one or more aspects described herein.

FIG. 28 depicts an exemplary relational database table having a representation of an organization attribute in accordance with one or more aspects described herein.

FIG. 29 depicts an exemplary Hibernate XML software code sequence for capturing a representation of an organization attribute in accordance with one or more aspects described herein.

FIG. 30 depicts an exemplary relational database table having information of extension attributes defined at different nodes in accordance with one or more aspects described herein.

FIG. 31 is a block diagram depicting exemplary Lightweight Directory Access Protocol (LDAP) schemas mapping attributes to a unified data model in accordance with one or more aspects described herein.

FIG. 32 depicts an exemplary input definition to the compiler describing the entities that will be stored in the database. For each entity definition, the necessary Java code and Hibernate XML mappings are generated.

### DETAILED DESCRIPTION

The aspects summarized above can be embodied in various forms. The following description shows, by way of illustration, combinations and configurations in which the aspects can be practiced. It is understood that the described aspects and/or embodiments are merely examples. It is also understood that one skilled in the art may utilize other aspects and/or embodiments or make structural and functional modifications without departing from the scope of the present disclosure.

For example, aspects and features of a method for modeling an object in an object-relational system are described in the context of modeling an object for use by a business, but it should be noted that the methods described herein can be used for modeling an object for use by any enterprise. In addition, although aspects relating to object-relational mapping often are described and examples are given with reference to the open source object-relational mapping software known as “Hibernate,” it should be noted that aspects described herein can be used by a person to extend any ORM software or to create a new ORM tool.

As noted above, an enterprise often makes a large investment in an enterprise system that meets almost all its objectives, but fails to meet a few. To meet this last mile of its objectives, an enterprise may require a small extension to its system's data model, such as having an additional attribute for an entity or some additional business logic. Aspects and features herein relate to an extension to the standard ORM to enable an enterprise to easily make extensions of its data model or add business logic to meet all of its needs. Other aspects relate to a system and method for enabling an enterprise to convert a database query constructed using Object Query Language (OQL) to a query in Structured Query Language (SQL) without having to know all of the information regarding the enterprise's relational database tables.

To build a enterprise ORM system that can support an enterprise such as Software-as-a-Service, all parts of the system, e.g., the Java object definition, the Hibernate XML coding, and the relational data table structure have to be consistent. In addition, the developer has to embed the concepts of visibility, rule based assignment and extension attributes. In accordance with aspects herein, the build environment has a code generator that takes the object structure as input and outputs the Java file, the XML mapping class and the data description language (DDL) to create the database tables.

Some background concepts are presented below relating to various components of an object-relational mapping system in accordance with aspects described herein.

An entity such as a business enterprise can model a concept of an entity relating to that enterprise and use such modeling information to maintain and use information relating to that entity. Some examples are of entities that can be modeled by an enterprise include user, bill of materials etc. In accordance with database principles known in the art, such entities can be modeled in either a relational programming environment or in an object-oriented environment such as the commonly used Java environment.

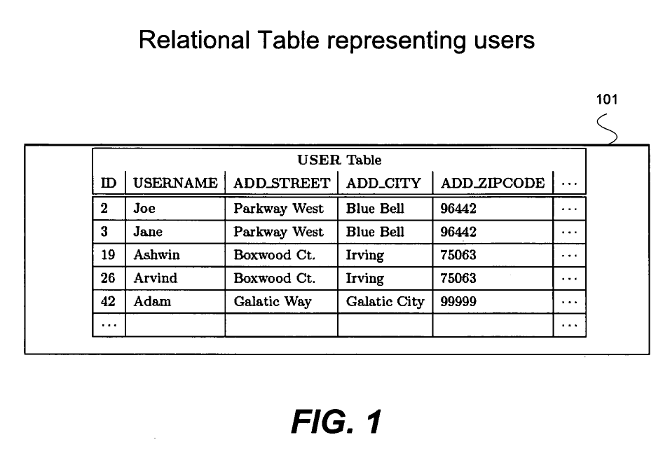

In a relational system, data is maintained in one or more data tables, where each row refers to an instance of the entity. For example, FIG. 1 depicts an exemplary data table in the relational environment, in this case a data table containing information regarding a database of “users.” As shown in FIG. 1, the USER table has a number of rows, each representing a user, and a number of columns, each containing information relating to an aspect of a user, such as “USERNAME,” containing a name of a user, “ADD_STREET,” containing street address information, “ADD_CITY,” containing city information, etc. As seen in FIG. 1, the record for a user named “Joe” is represented in a relational system by a row in the USER table, and is identified by an identification number, in this case ID 2.

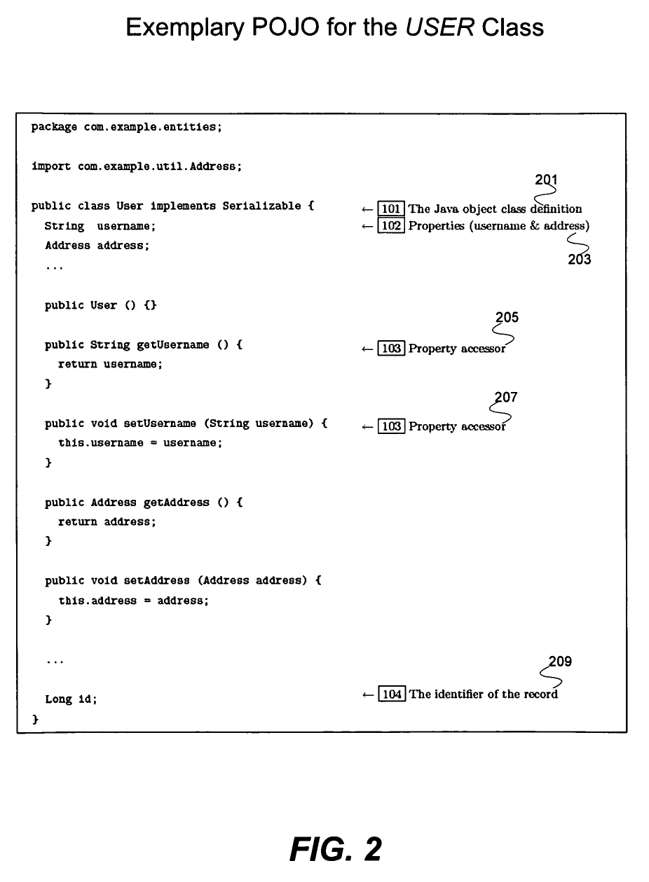

In an object system, an entity concept is modeled using classes, where each instance of the class—called an object—refers to an instance of the entity. For example, as shown in FIG. 2, the class com.example.entities. User may be used to model the concept of user in an object/class environment such as Java. As seen in FIG. 2, the equivalent representation in an object/class environment like Java is represented by the class com.example.entities. User 201. In a Java environment, these classes are often referred to as “Plain Old Java Objects” (POJOs). Each class has one or more attributes that characterize each instance of the class—i.e., each object. Thus, the corresponding instance of the object user in the class com.example.entities. User will have the attributes id 209=2, username 203=Joe, and so forth.

In the object-oriented environment, object-relational mapping (ORM) software such as Hibernate can perform mapping between the table row and the corresponding attributes of the object. For example a possible specific embodiment of the mapping may be:

| | | |
|---|---|---|
| Object model | [symbol] | Relational Model |
| id | [symbol] | ID |
| username | [symbol] | USERNAME |
| address | [symbol] | ADD_STREET, |
| | | ADD_CITY, and |
| | | ADD_ZIPCODE |
| | . . . | |

This mapping data could be specified using an xml file or a Java annotation, etc.

In general, any object-relational system consists of three elements: (1) the relational part, i.e., the table; (2) the object part, i.e., the class; and (3) the mapping, i.e., the xml document mapping the object-oriented components to their corresponding components in the relational system.

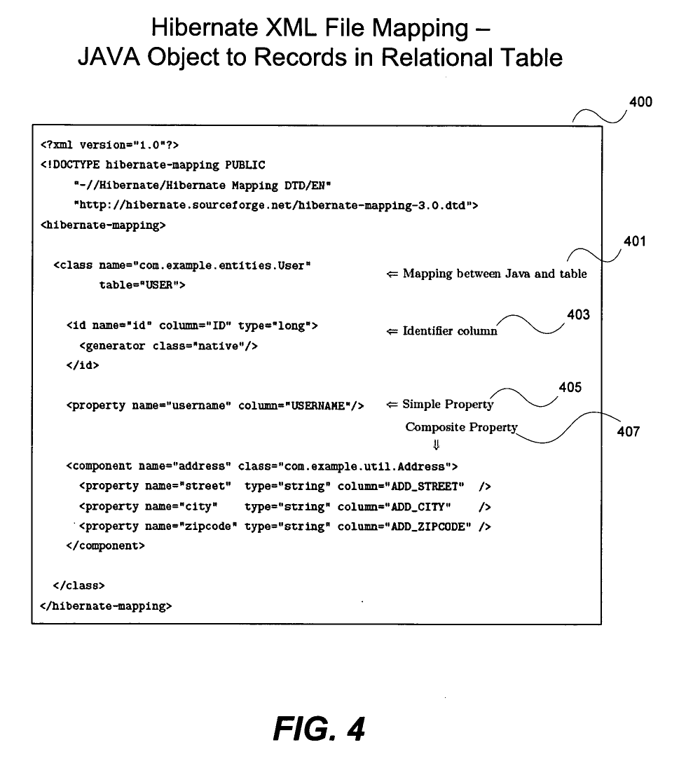

One example of object-relational data mapping in the Hibernate environment is shown in FIG. 4. FIG. 4 shows the User.hbm.xml file 400 that is used by Hibernate. This xml file shows the mapping 401 between the Java class com.example.entities. User and the table USER, the mapping 403 between Java ID name id and relational column “ID”, mapping 405 between Java object simple property name username and relational column USERNAME and mapping 407 between a Java object composite property address, which comprises multiple components “street,” “city,” and zipcode,” which map to relational columns “ADD_STREET,” “ADD_CITY,” and “ADD_ZIPCODE,” respectively.

Hibernate provides an application programming interface (API) using the interface org.hibernate.Session to perform the standard database operations create, read, update and delete (CRUD). The following code snippets create a new object instance of user and persist the data into the relational table using the API provided by Hibernate:

| | |
|---|---|
| User u = new User ( ); | // Creating a new User object |
| ... | |
| session.save (u); | // Propagating changes to database |

This will result in a new record in the USER table. The column ID will be automatically generated based on the policy specified for identifier generation and the underlying database.

Similarly the org.hibernate.Session provides an interface to read an object (i.e., the user Joe is loaded into memory),

| | |
|---|---|
| User u = session.load (User.class, 2); | // Joe’s identifier (ID) is 2 |

modify the object (Joe’s zipcode is modified to 94662),

| | |
|---|---|
| u.getAddress ( ).setZipcode(“94662”); | // Updating Joe’s address for the object |
| session.update (u); | // Propagating changes to database |

and delete an object (Joe is removed from the system)

| | |
|---|---|
| session.delete (User.class, 2); | // Deleting “Joe” from object-relational |
| | // system. |

An object-relational mapping system also can model attributes of an entity to information regarding a record in a relational data table. These attributes are known in the art as either a “fundamental” type attribute or a “composite” type attribute.

Some fundamental data types such as “string,” “integer,” etc., correspond to a data type in a relational database as shown in the table below:

| Object Type | Database Type |
|---|---|
| java.lang.String | VARCHAR |
| java.lang.Integer | NUMBER |
| java.lang.Double | NUMBER |
| java.sql.Date | DATE |
| . . . | . . . |

For example, the user object defines several attributes—username, address, etc. These attributes map to one or more columns in the database. A simple attribute like username maps to a single column USERNAME in the table. The object type and the database type have to match. As shown in the table above, an object type java.lang.String maps to a data type VARCHAR in the database. The xml code snippet
<property name=“username” column=“USERNAME” type=“string”/>
   creates a mapping between the USERNAME column and the object property username and indicates that the two have the same data type, i.e., “string” in this particular case.

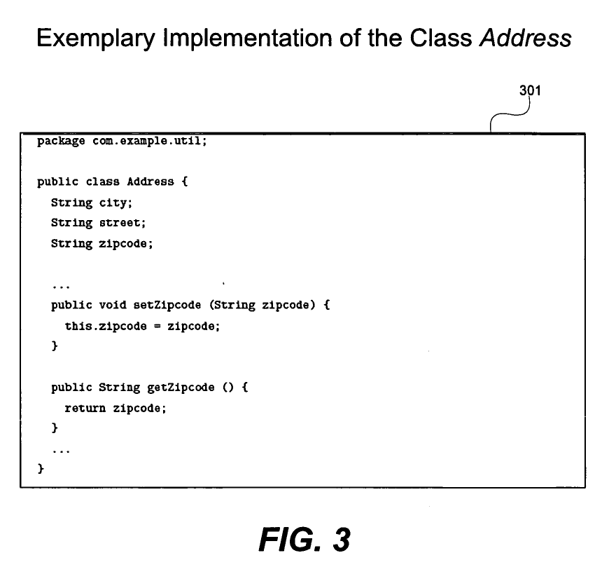

A “composite” object type is represented as a class in the object environment. For example, com.example.util.Address is a collection of three attributes of fundamental type. For example, as shown in the object code 301 in FIG. 3, the object property address has three attributes, city, street, and zipcode. Such attributes of composite types are mapped to multiple columns. The xml code snippet

```
<component name=“address” class=“com.example.util.Address” >
  <property name=“street” type=“string” column=“ ADD_STREET”/>
  <property name=“city” type=“string” column⁼“ ADD_CITY” />
  <property name=“zipcode” type=“string”
  column=“ ADD_ZIPCODE” />
</component>
```

creates the mapping between the columns ADD_STREET, ADD_CITY, and ADD_ZIPCODE in the relational data table and the object property address.

“Entities” are persistent types that represent first-class business objects. In other words, there may be some types (or classes) that are more important then others, and those types of objects may be known as “first-class” business objects. For example, the object com.example.entities. User is a first-class business object that has an associated table USER in the database. There also are value types such as java.lang.String and com.example.util.Address that do not have an associated table. Thus, two users having the same address will refer to two different instances of com.example.util.Address, and modifying Joe's zipcode does not change the zipcode for Jane.

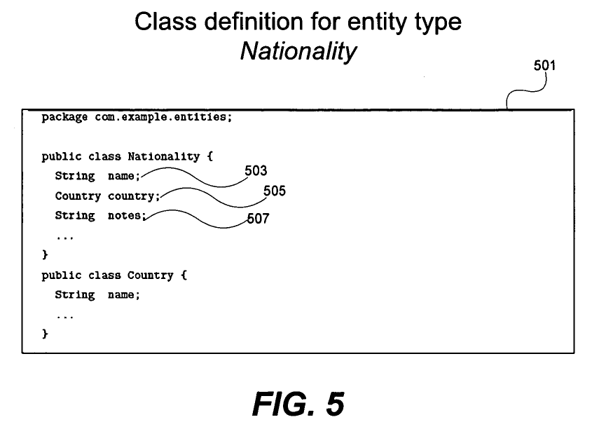

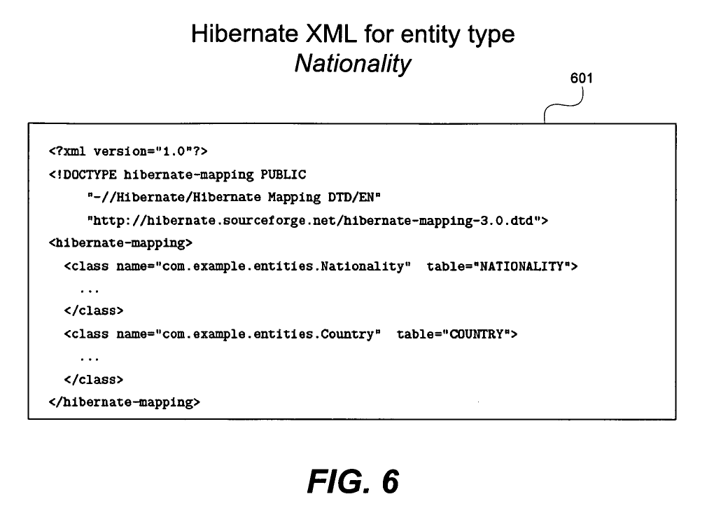

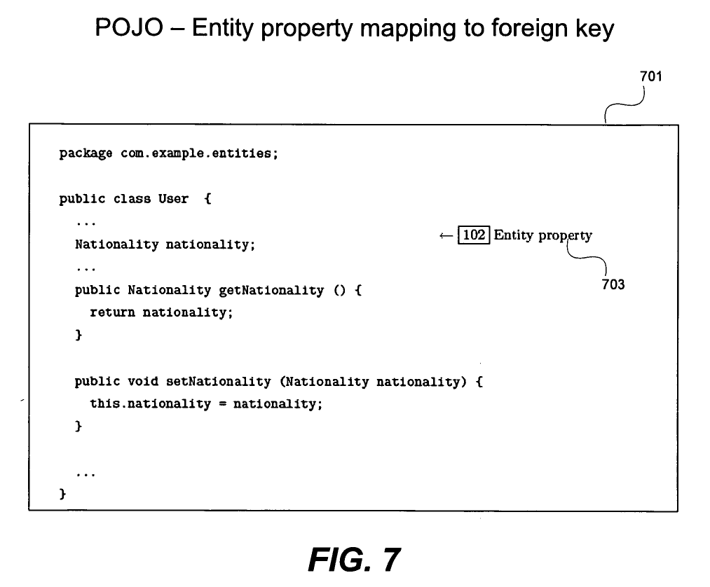

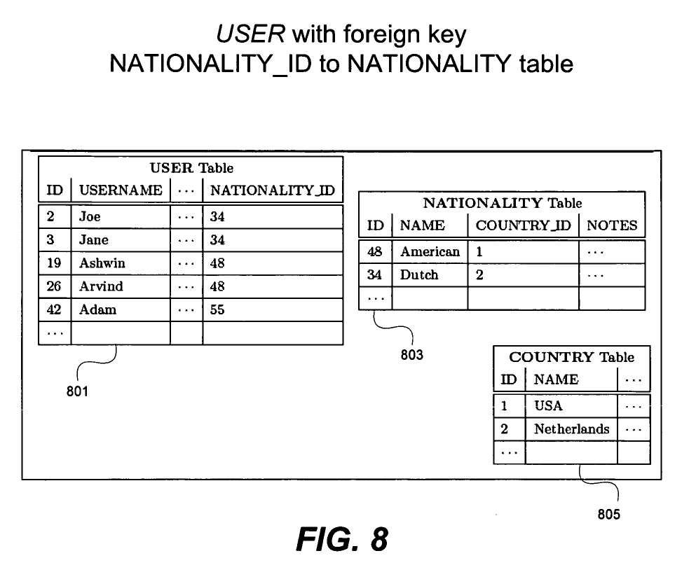

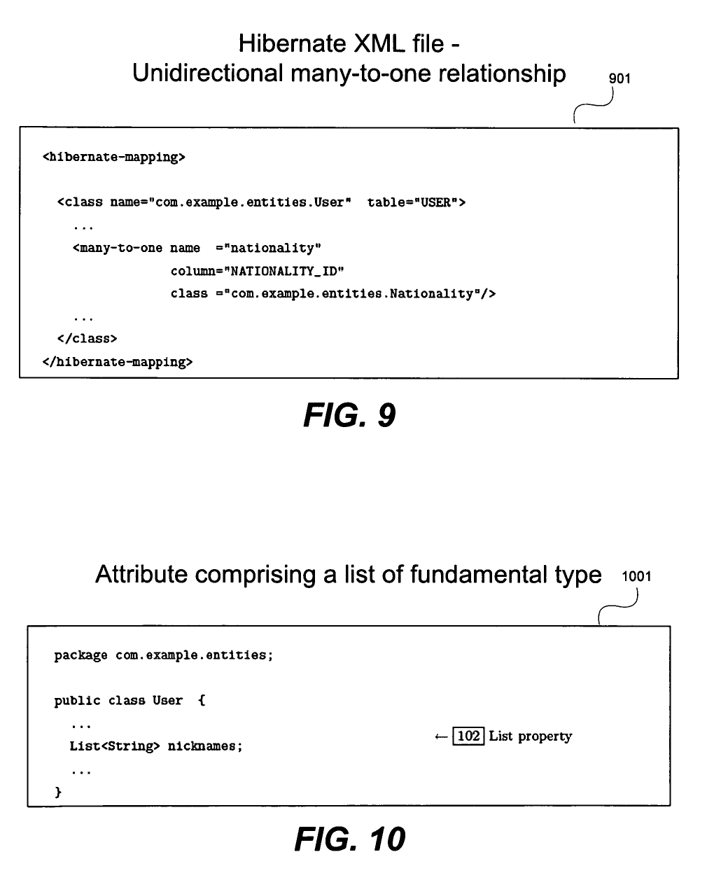

Similarly, Nationality and Country also are examples of first-class business objects. For example, FIG. 5 depicts an exemplary object code sequence 501 representing a class definition for an entity type Nationality. As shown in FIG. 5, the entity type Nationality has three attributes, name 503, country 505, and notes 507. FIG. 6 depicts an exemplary Hibernate xml code sequence 601 that maps the entity type Nationality to relational data tables NATIONALITY and COUNTRY. FIG. 7 depicts an exemplary Java code sequence referring to an instance of a User's nationality and setting that nationality to a particular country. In addition, as shown in FIG. 8, both users Joe and Jane in USER table 801 refer to the same instance of Nationality, i.e., NATIONALITY ID 34. So in the USER table, instead of storing user's actual nationality, we store a reference to the entity object com.example.entities.Nationality. Storing a reference to an object in this manner is known in the art as “having a foreign key” in the database. The xml code snippet

```
<many-to-one name =“nationality”
    column=“ NATIONALITY_ID”
    class =“com.example.entities.Nationality” />
```

creates a mapping between the column NATIONALITY_ID and the object attribute nationality. When the attribute nationality is accessed, the corresponding entity object of the type com.example.entities.Nationality is returned rather than just an ID for the object.

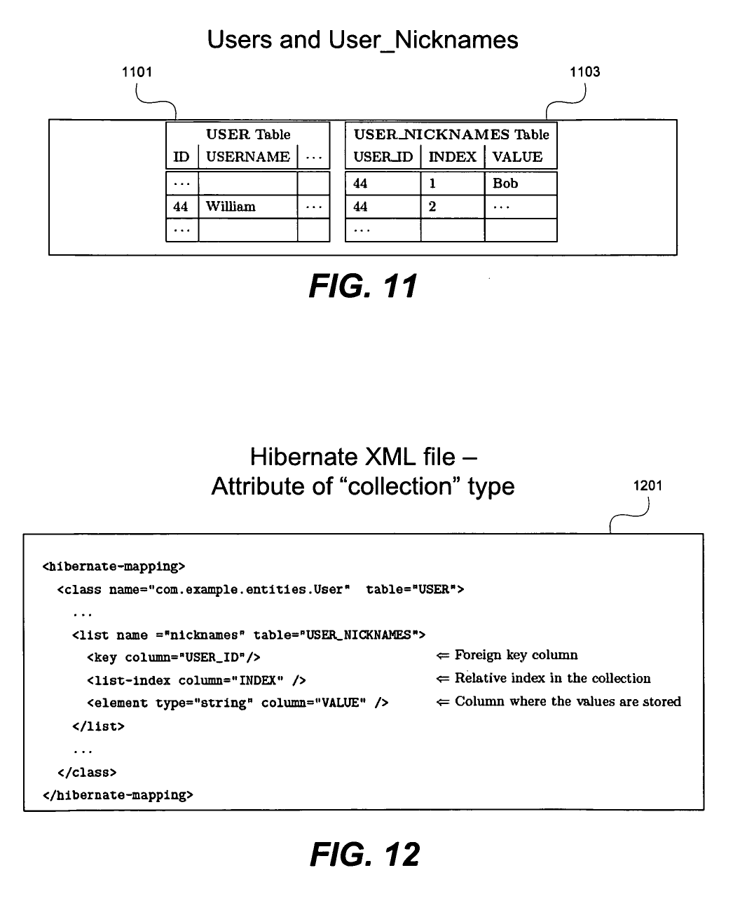

In addition to having simple attributes, an entity can have attributes having a collection of values. For example a user can have multiple nicknames or multiple secondary addresses or multiple secondary nationalities. Such attributes are usually modeled as a collection in the object environment and a secondary table in a database. For example, the software code snippet 1001 in FIG. 10 depicts an attribute nicknames whose values comprise a list of fundamental type <string>. See also FIG. 11, which depicts USER table 1101 and USER_NICKNAMES table 1102, and Hibernate XML code snippet 1201 in FIG. 12, which models the object nicknames on the data in the relational tables 1101 and 1102 shown in FIG. 11. As seen in FIG. 11, the entry for “William”, which corresponds to ID 44 in USER table 1101, has multiple values, i.e., a collection or list of values in USER_NICKNAMES table 1102. The Hibernate XML code snippet shown in FIG. 12 also reflects that the values for the attribute nicknames for entity com.example.entities.User comprise a list, i.e., multiple values.

Of course, data in an enterprise does not exist simply to reside in a database, but instead is used by an enterprise to meet its needs. The open-source object-relational mapping software Hibernate (and other ORM technologies) provide mechanisms to query data in the database so that it can be analyzed and otherwise by an enterprise. The defacto query language for relational data systems is structured query language (SQL). However, SQL does not map cleanly to the object system. For example, the SQL query in the relational environment for finding the users living in zipcode 75025 is:

select u. ID
from USER u
where u. ADD_ZIPCODE = 75025

However, the SQL query is not well formed in the object world because the attribute ADD_ZIPCODE is not defined in the object world. Instead, the object-centric system has its own protocols for constructing a query for data in an object-oriented data system, such as the Hibernate Query Language (HQL). Thus, a corresponding object-centric query for finding the users living in zipcode 75025 can take the form

from com.example.entities.User

where equals (address.zipcode, 75025)

It is much easier for programmers to write a query in an object-oriented language such as Java than in SQL, and therefore it is desirable to provide a method for converting a query constructed using an object centric language into SQL. Thus, according to aspects herein, there is provided a method and system for accomplishing such a query conversion. For purposes of the present disclosure, the object-centric query language shall be referred to as “Object Query Language (OQL)” and the module that converts an OQL to SQL shall be referred to as a “Query Processor.”

A statement in OQL consists of two parts: the entity being searched for, e.g., (com.example.entities.User) and the predicate (address.zipcode=75025) that specifies the search (or filter) criteria. A predicate can be further broken down into various components, path, operator and value, as illustrated below:

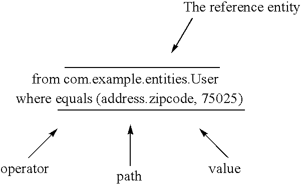

As discussed in more detail below, the path is only applicable within the context of the reference entity. For example, the path address.zipcode may not be applicable for the entity com.example.entities.Country.

We can look at another example of OQL. In this example, a list of users with country of nationality as USA is given as

from com.example.entities.User

where equals (nationality.country.name, “USA”).

The query processor can generate a number of possible SQL statements.

A first possible statement is output in terms of relational language:

```
select u.ID
from USER u, NATIONALITY n, COUNTRY c
where u.NATIONALITY_ID = n.ID and
    n.COUNTRY_ID = c.ID  and
    c.NAME = “USA”
```

A second possible statement is output in terms of an object language:

```
select u.ID
    from USER u
    where exists (select n.ID
            from NATIONALITY n
            where u.NATIONALITY_ID = n.ID and
                exists (select c.ID
                    from COUNTRY c
                    where n.COUNTRY_ID =c.ID and
                        c.NAME = “USA”)).
```

In accordance with aspects herein, the query processor generates SQL statements from the OQL statement. As shown in the example above, the SQL generated is not unique. Based on empirical data, the query processor will generate one of the multiple possible SQL statements that will be efficient to execute. The query processor will collect timing information for each of the SQL statements executed, and, depending on the tables being referenced, the list of attributes, and types of attributes being queried, will pick one of the realizations to execute.

Next we discuss the concept of “path.” Any entity has a list of paths that include all the attributes of the entity. For example, the entity com.example.entities. User has the following paths.

| Path | Type |
|---|---|
| username | java.lang.String |
| address | com.example.util.Address |
| nationality | com.example.entities.Nationality |
| nicknames | List[java.lang.String] |

All paths have a type that is derived from the attribute type. For example, the attribute username is of type java.lang.String, hence the type of the path is java.lang.String.

The attributes of a path result in additional paths for the entity. For example the path address of type com.example.util.Address has three attributes: street, city, and zipcode as shown in the FIG. 3. Therefore in addition to the paths described in the above table, the table below shows additional paths for the entity com.example.entities.User:

| Path | Type |
|---|---|
| address.street | java.lang.String |
| address.city | java.lang.String |
| address.zipcode | java.lang.String |

Similarly, the entity com.example.entities.User has an attribute nationality having an entity type, i.e., the entity com.example.entities.Nationality. As shown in FIG. 5, the entity com.example.entities.Nationality has the attributes name 501, notes 503, and country 503, and thus the table below lists some additional paths of the entity com.example.entities.User relating to the User attribute nationality.

| Path | Type |
|---|---|
| nationality.name | java.lang.String |
| nationality.notes | java.lang.String |
| nationality.country | com.example.entities.Country |
| . . . | |

We now discuss the concept of a “predicate.” A predicate is the filtering condition in an OQL statement. Informally, the grammar for predicate can be given as

```
predicate := <binary operator> (<path>, <value> )
        | <unary operator> (<path>)
        | <list operator> (<predicate>+)
```

where the operators are

| Type | Operator | Example | SQL Mapping |
|---|---|---|---|
| List | and | and (<a list of predicates>, . . . ) | AND |
| List | or | or (<a list of predicates>, . . . ) | OR |
| Binary | Equals | equals (<lhs path>, <rhs>) | = |
| Binary | startsWith | startsWith (<lhs path>, <rhs>) | LIKE |
| Binary | endsWith | endsWith (<lhs path>, <rhs>) | LIKE |
| Binary | Less | less (<lhs path>, <rhs>) | < |
| Binary | Greater | greater (<lhs path>, <rhs>) | > |
| Unary | Nil | nil (<lhs path>) | IS NULL |
| . . . | | | |

Some examples of predicates for the entity com.example.entities.User are set forth in the following paragraphs.

For example, a predicate in OQL to obtain a list of users with username starting with “A” can be an object-oriented expression such as:

startsWith (username, A)

where starts With is an operator, username is a path of the entity com.example.entities.User, and A is the filtering condition.

The corresponding SQL query might be

select USER.ID

from USER u

where u.USERNAME like ‘A %’

Similarly, a predicate in OQL to obtain list of users who have a nickname starting with “A” can be an object-oriented expression:

startsWith (nicknames, A)

In the relational database, there are two data tables that must be referenced in order to obtain this information, the USER table and a second table of USER_NICKNAMES. Thus, the corresponding SQL query might be

```
select USER.ID
from USER u
where exists (select 1
        from USER_NICKNAMES n
        where u.ID = n .USER_ID and
          n.VALUE like ’A%’).
```

As another example, a predicate in OQL to obtain a list of users in the USA and having a username starting with “A” can be the object-oriented expression:

```
and (
  startsWith (username, “A”),
  equals (nationality.country.name, “USA”));
```

The corresponding SQL might be

```
select USER.ID
from USER u
where exists (select 1
        from USER_NICKNAMES n
        where u.ID = n.USER_ID and
  n.VALUE like ’A%’)
    AND
    exists (select 1
        from NATIONALITY n
        where u.NATIONALITY_ID = n.ID and
            exists (select 1
                from COUNTRY c
                where n.COUNTRY_ID = c.ID and
                  c.NAME = USA)).
```

All of these concepts are used in a business object modeling system and method in accordance with aspects and features described herein.

As noted above, some aspects described herein relate to a method and system that can implement entity extensions. Attributes that are part of an extension of an entity are called data-driven attributes. Attributes that are specified in the code, e.g., java class definition, xml and database columns and tables, are henceforth called the “core attributes” of an entity. Attributes that are specified after the deployment through data are called “extension attributes.”

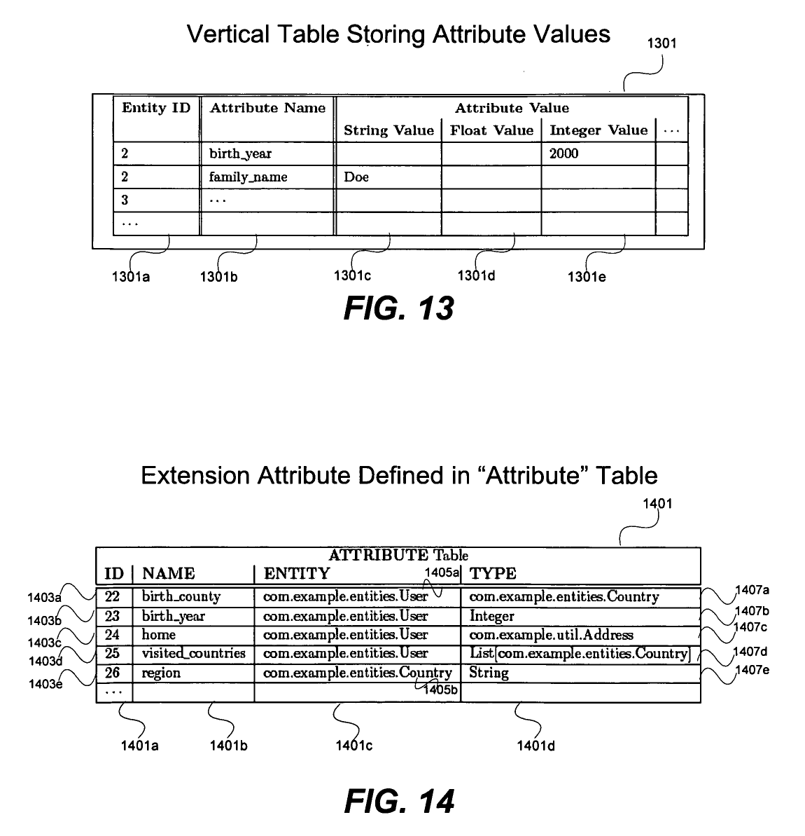

The values of extension attributes are often stored in the format of name-value pairs or in a vertical schema such as vertical table 1301 shown in FIG. 13. As shown in vertical table 1301, in the vertical schema there are three columns: the first column 1301a uniquely identifies the entity, the second column 1301b identifies the extension attribute, i.e., the attribute name, and the third column stores the value of the attribute as either a string value 1301c, a float value 1301d, or an integer value 1301e.

In conventional object-oriented programming, a programmer using the object-centric interface has to access/modify the core attributes using one set of interfaces and access/modify the extension attributes using a different set of interfaces. For example, if a programmer wanted to obtain a list of users born after the year 2000, she may wish to write a query to obtain such information. However, a query such as

from.com.example.entities.User

where birth_year>2000

is not supported in standard OQL because birth_year is not a core attribute but is instead an extension attribute, and so the programmer would have to write the query using SQL. However, SQL is more complicated to write. To write an SQL query, a programmer would have to use the name-value pair tables for storing attribute values, know the structure of the data tables containing information for both core and extension attributes and know the mappings between attributes and the relational tables. By using the name-value pair tables for storing attribute values, the standard query languages provided by ORMs break the fundamental tenets of object-oriented programming. i.e., encapsulation of data and hiding of the way in which the data is implemented. The loss of implementation hiding (that is, how the hiding extension attributes are stored) curtails the future enhancement and may change or inhibit the development of storage mapping logic that may provide better performance.

To address these problems between object-oriented and relational database-oriented programming, aspects and features described herein provide a uniform object-centric interface to both core and extension attributes. Thus an enterprise application built using an extended ORM as described herein can provide:

a uniform mechanism to access and edit core and extension attributes,

an object-oriented programming interface to encode business logic, and

a uniform mechanism to query entities.

The way in which core attributes of various types (fundamental, composite, entity and collection) can be specified and the way in which their values can be mapped to the relational system using an ORM were described above.

We now present an embodiment of how extension attributes of various types can be specified and how their values can be mapped to the relational system in accordance with one or more aspects and features of an object modeling system and method described herein.

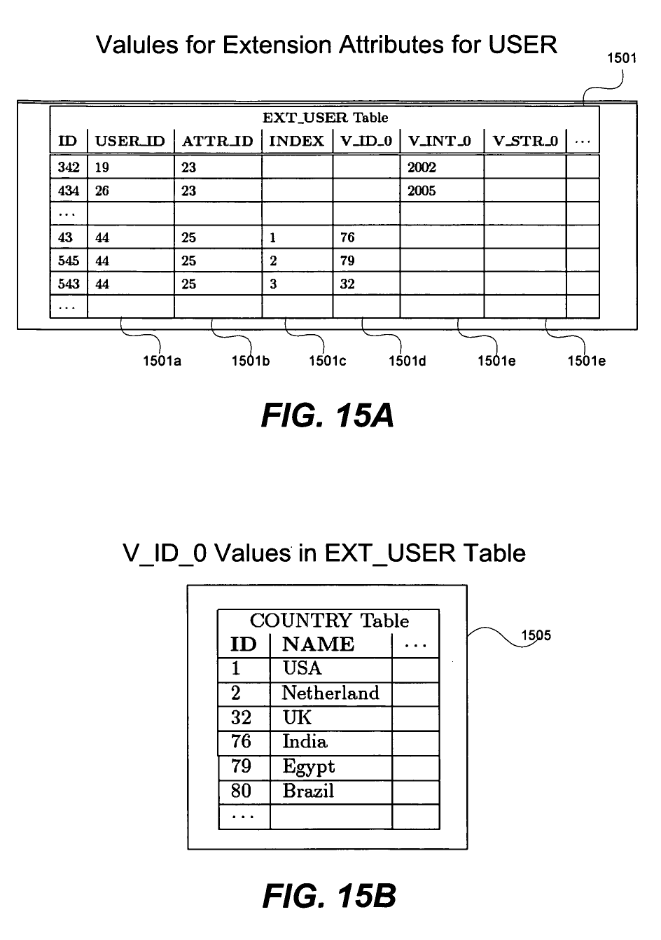

The attribute values for entities are stored in attribute value tables. Each entity has an associated attribute table. The specification of extension attributes are stored in an ATTRIBUTE table that maps to the object type com.example.entities.Attribute. The tables that start with an “EXT_” prefix store values for extension attributes for that entity (the prefix EXT_is a convention). For example, the core attribute values for the entity com.example.entities.User are stored in the USER table and the extension attribute values are stored in an EXT_USER table such as EXT_USER Table 1501 shown in FIG. 15A.

As shown in FIG. 14, each record in the ATTRIBUTE table 1401 denotes an exemplary extension attribute for an entity.

The fields of ATTRIBUTE table 1401 shown in FIG. 14 include:

ID 1401a: An identifier for the attribute (a primary key). The ID field is used in attribute value tables like EXT_USER where the values of the attributes for com.example.entities.User are stored.

NAME 1401b: Name of the attribute, for example, birth_country 1403a, birth ear 1403b, home 1403c, visited_countries 1403d, or region 1403e. This attribute name can be used in generation of path and predicates.

ENTITY 1401c: Name of the entity that is being extended, for example, com.example.entities.User 1405a or com.example.entities.Country 1405b.

TYPE 1401d: The object type of the extension attribute. This dictates where the information regarding the attribute value is stored in the attribute value tables. For example, if the type is Integer, then the value of the attribute is stored in the V_INT_0 column. If the type is String, then the value of the attribute is stored in the V_STR_0 column. If the attribute is of composite type, then the value is stored in one or more columns, each having data of the attributes relating to that entity.

In accordance with aspects described herein, an entity object can be extended with attributes of either a fundamental or a composite type as described above. As noted above, the values of the extension attributes for the entity com.example.entities.User—both fundamental and composite types—can be stored in a table such as the EXT_USER table 1501 shown in FIG. 15A.

Thus, as shown in the exemplary ATTRIBUTE table 1401 in FIG. 14, the entity com.example.entities.User 1405a has been extended by adding attributes in ATTRIBUTE table 1401 such as birth country 1403a, birth_year 1403b, home 1403c, and visited_countries 1403d, and the entity com.examples.entities.Country 1403e can be extended by adding an attribute region 1403e. These attributes can be of types com.examples.entities.Country 1407a (i.e., an entity type), Integer 1407b (i.e., an integer type), com.example.util.Address 1407c (i.e., a composite type), List[com.examples.entities.Country] 1407d, and String 1407e, respectively.

As shown in FIG. 15A, the value of an attribute of fundamental type is given by a record in the EXT_USER table 1501 with the attribute's identifier in ATTR_ID and user's identifier in USER_ID. For example, as shown in EXT_USER table 1501, the value of birth year (ATTR_ID=23) for a particular user (USER ID=19) is 2002, and because this value is an integer, it is stored in the column 1503d labeled V_INT_0.

An entity object also can be extended by adding collections of fundamental types. For example, as shown in ATTRIBUTE Table 1401 in FIG. 14, the record with ID 25 can add an extension attribute of collection type named visited_countries 1403d to the entity com.example.entities.User 1405a. The values of this extension attribute comprise a list of entities, shown in FIG. 14 as List[com.example.entities.Country] 1407d. The values for this attribute of the entity com.example.entities.User 1405a are stored in multiple records in the EXT_USER Table shown in FIG. 15A. For example, as shown in FIG. 15, the value of visited_countries (ATTR ID=25) for a user (USER ID=44) is the set {76, 79, 32} of the identifiers from the COUNTRY Table 1505 shown in FIG. 15B stored in V_ID_0. As shown in FIG. 15A the records with ID=43, 545 and 543, William (USER ID=44) has visited India, Egypt and UK. The ATTR_ID=25 correspond to the attribute visited_countries and as shown in FIG. 15B, the values 76, 79 and 32 respectively, correspond to the countries India, UK and Egypt. Given that visited_countries is a List, the field INDEX 1503c specifies order in which the values are stored in the list.

An entity object also can be extended with attributes of an entity type. For example, as shown in ATTRIBUTE Table 1401 in FIG. 14, the record with ID 22 adds an extension attribute of entity type named birth country 1403a to the entity com.example.entities.User, and this extension attribute is of entity type com.example.entities.Country 1407a. The value of this attribute can be given by a record in an EXT_USER Table in column 1503e V_ID_0. As shown in FIG. 15A and FIG. 15B, the record with ID=478, William (user with ID=44) was born in Brazil. The ATTR_ID=22 corresponds to the attribute birth country and the value of 80 in V_ID_0 corresponds to the country Brazil.

In the case of the attribute home 1403c having an attribute of composite type com.example.util.Address 1407c, the value of home comprises the attributes of com.example.util.Address, and the values of those attributes are stored in one or more appropriate columns in an EXT_ATTRIBUTE table such as EXT_USER Table 1501 shown in FIG. 15A. The entity com.example.util.Address has three attributes, zipcode, city, and street, each of type java.lang.String. Consequently, the value of the extension attribute in the ATTRIBUTE table of type com.example.util.Address is stored in one or more columns V_STR_0, V_STR_1 and V STR_2 in EXT_USER Table 1501, each containing the value of one of the three attributes zipcode, city, and street.

Features of an extendable ORM described herein also provide a uniform interface to interact with both core and extension attributes. These and other features can enable an enterprise to interact with both core and extension attributes of entities corresponding to records in an enterprise database and can enable enterprise personnel to write business logic that is not dependent on the storage mechanism of the attribute values.

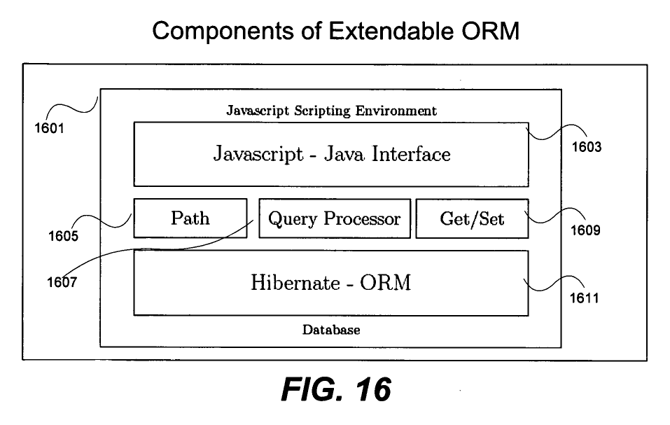

Exemplary components of an extendable ORM method and system in accordance with aspects and features described herein are shown in FIG. 16. As shown in FIG. 16, an extendable ORM can include a standard ORM toolkit 1611, a component 1605 that encapsulates the concept of “path” hiding the implementation differences between extension and core attributes, a query processor 1607 that takes an OQL and generates the corresponding SQL, a java interface 1609 to access the attributes (get function) and modify the attributes (set function). In addition, a java-javascript bridge 1603 (like rhino, an open source implementation of javascript scripting language) that provides a Javascript Scripting environment.

Features of an extendable ORM method and system in accordance with one or more aspects and features described herein can be used to extend the concept of “path” discussed above. In accordance with aspects herein, the concept of path can be extended with the concept of extension attributes discussed just above. As shown in FIG. 14, an entity com.example.entities.User 1405b has extension attributes birth_country 1403a, birth ear 1403b, home 1403c and visited_countries 1403d. The entity com.example.entities.Country 1405b has an extension attribute region 1403e. Thus, in addition to the core paths for the entity com.example.entities. User such as “username,” “address,” “nationality,” “nickname,” “address.zipcode,” etc., as described above, the following additional paths can also be defined for the entity com.example.entities.User:

| Path | Type |
|---|---|
| birth year | java.lang.Integer |
| Home | com.example.util.Address |
| home.street | java.lang.String |
| . . . | |
| visited_countries | List[com.example.entities.Country] |
| visited_countries.name . . . | java.lang.String |
| nationality.country | Com.example.entities.Country |

In the definition of path, the system provides an interface where the user does not need to be aware of whether an attribute is a core attribute or an extension attribute.

In the above table, we have paths visited_countries and nationality country of type com.example.entities.Country (or a collection of com.example.entities.Country). Table 1401 defines an extension attribute region for entity com.example.entities.Country. Thus the following are also valid paths for the entity com.example.entities.User:

| Path | Type |
|---|---|
| [visited_countries.region | java.lang.String |
| nationality.country.region | java.lang.String |

Note that in the above table, the paths ending with region are a result of the extension of the entity com.example.entitiesCountry.

In the definition of path, the system provides an interface where the user does not need to be aware of whether an attribute is a core attribute or an extension attribute.

As discussed in more detail below, using an extension of the path in accordance with aspects herein can enable an enterprise to:
implement a unified query mechanism, i.e., OQL statements can be used without the need to write SQL queries;
implement a unified interface for accessing and modifying attributes of an entity, and
implement a unified interface for writing business logic in a scripting environment, where paths are first-class object properties.

As noted above, features described herein can enable an enterprise implement a unified query mechanism, i.e., to more easily query its databases by using OQL rather than SQL queries. The interface to the query specification to obtain values of both extension and core attributes is the same. For example, the predicate for a list of users with birth year after 2000 can be given as
greater (birth_year, 2000)
   Such a query seeks information regarding the extension attribute birth_year. However, as noted above, the standard query languages provided by conventional ORMs do not support such a query, and an SQL query would have to be written instead. In accordance with aspects described herein, a query processor such as Query Processor 1607 shown in FIG. 16 can generate the SQL query that is executed on the database looking for birth year in the attribute value table.

Exemplary ways in which such an SQL query can be generated from a query presented as an OQL query are discussed below.

A first example is generation of an SQL query from the OQL query for a list of users having a birth year after 2000. The predicate for this query is specified as

greater (birth_year, 2000)

The corresponding SQL query generated by the Query Processor might be

```
    select u.ID
    from USER u
where exists (select 1
            from EXT_USER e
            where e.USER_ID = u.ID and
                e.ATTR_ID = 23 and
                e.V_INT_0 > 2000)
```

where the attribute identifier in an extension attribute table such as ATTRIBUTE Table 1401 shown in FIG. 14 for the extension attribute birth ear is e.ATTR_ID is 23 and the value for that attribute is stored in the V_INT_0 column 1503e in ATTRIBUTE Table 1401.

A second example is a query to obtain a list of users who have a country in the “Europe, Middle East, and Africa” region, often abbreviated as “EMEA”. The predicate for such a list can be expressed as

equals (visited_countries.region, “emea”)

The equivalent SQL query that can be generated by the Query Processor to obtain this same information from ATTRIBUTE Table 1401 might be

```
select u.ID
from USER u
where exists (select 1
        from EXT_USER eu
        where eu.USER_ID = u.ID and
            eu.ATTR_ID = 25 and
                exists (select 1
                        from COUNTRY c
                        where eu.V_ID_0 = c.ID and
                            exists (select 1
                                    from EXT_COUNTRY ec
                                where c.ID = ec.ID and
                                    ec.ATTR_ID = 26 and
                                  ec.V_STR_0 =“emea”)))
```

A third example is a composite query to obtain a list of who have both a country in the “EMEA” region and a birth year after 2000. In OQL language, this is just a concatenation of the predicates shown above:

and (
equals (visited_countries.region, “emea”),
greater (birth_year, 2000)
);

The equivalent SQL query generated by Query Processor 1607 also is a combination of the previous queries:

```
select u.ID
from USER u
where exists (
    select 1
from EXT_USER e
        where e.USER_ID = u.ID and
            e.ATTR_ID = 23 and
            e.V_INT_0 > 2000 and
                exists (
                select 1
                from EXT_USER eu
                where eu.USER_ID = u.ID and
                    eu.ATTR_ID = 25 and
                    exists (
                      select 1
            from COUNTRY c
            where eu.V_ID_0=c.ID and
                                exists (
                                  select 1
                                    from EXT_COUNTRY ec
                                    where c.ID = ec.ID and
                                      ec.ATTR_ID = 26 and
                                      ec.V_STR_0 = “emea”))))
```

Other features of a business object modeling system and method as described herein provide a mechanism to access/update the value for both core and extension attributes using a uniform interface.

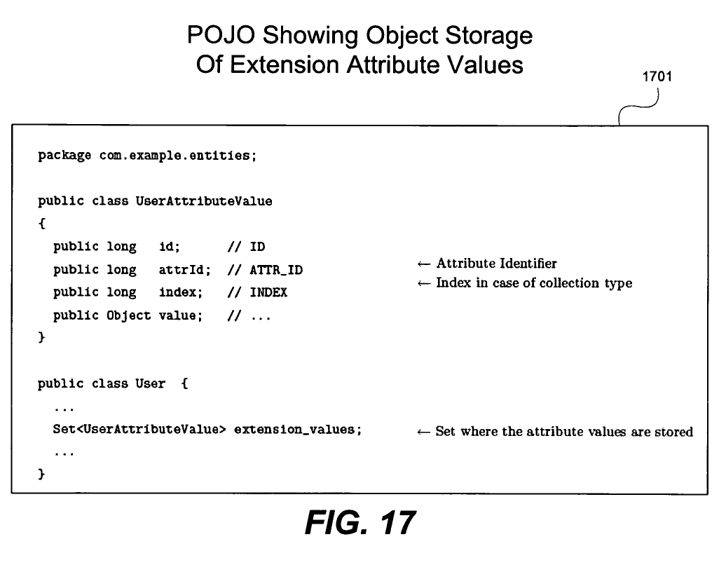

The exemplary software code portion 1701 shown in FIG. 17 illustrates the use of class variables to store the extension values. For each of the core attributes an field is declared for the class, and the values for extension attributes are stored in the variable extension_values 1703.

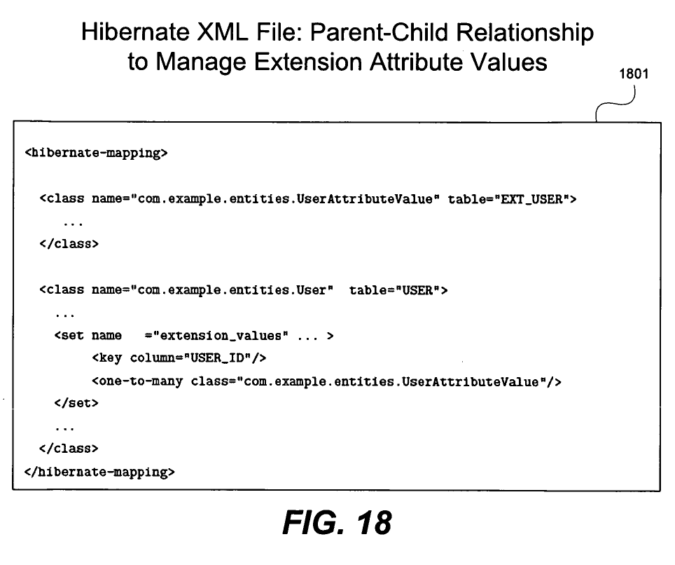

Whenever the ORM loads an entity object, it loads the values for the extension attributes into the field “extension_values.” When the entity object is updated/saved to the database, the extension attributes in the field extension_values are stored in the database. For example, as shown in FIG. 17, the field extension_values for the entity type com.example.entities.User is a collection of values for com.example.entities.UserAttributeValue 1705. FIG. 18 depicts an exemplary xml hibernate mapping between the java object com.example.entities.UserAttributeValue and the corresponding database table EXT_USER 1803 and the mapping between the field extension_values for the java object com.example.entities.User and the database relationship between the two.

A uniform interface in accordance with aspects herein can provide attribute-type-independent methods to get and set the values of attributes rather than the conventional methods used in standard ORM implementation such as getusername( ) and set UserName( . . . ).

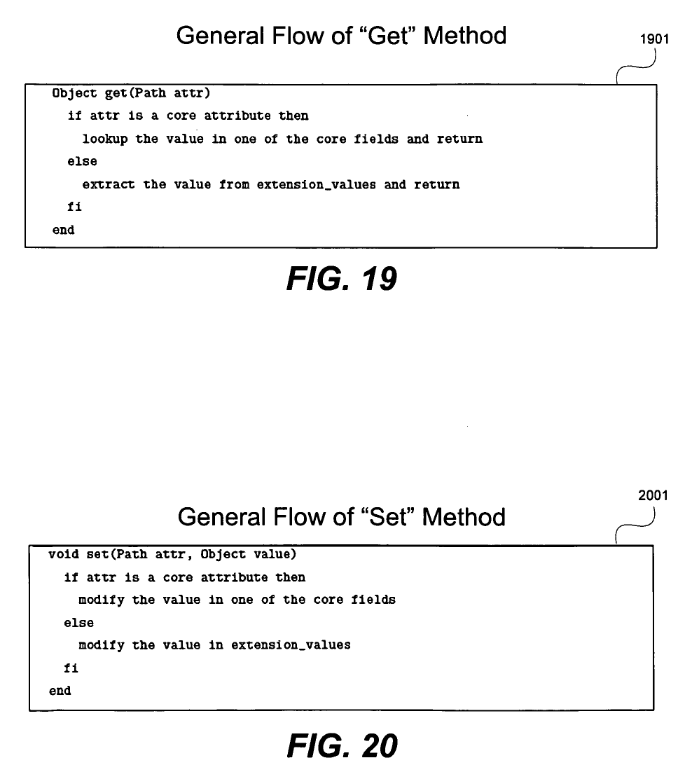

FIGS. 19 and 20 illustrate an exemplary implementation of the uniform interface. As shown in the exemplary code sequence 1901 in FIG. 19, the get method inspects the attribute path being passed. If the path references a core attribute, then the corresponding getter method is called. For example, for the attribute username, the corresponding conventional command to get the value is getUsername( ) and that is the command that the system calls. However, if the path references an extension attribute rather than a core attribute, then the value is looked up from the class member “extension_values.” Similarly, as shown in the exemplary code sequence 2001 in FIG. 20, the set method inspects the attribute path and decides to either call the corresponding setter method for core attributes, for example, setUsername( ), or update the value in the member field “extension_values” if the attribute is an extension attribute.

For example, an exemplary code sequence to get the value of a core attribute using the type-independent get function described above is:

User u = session.load (2);
value = u.get (“address.zipcode”); // accessing a core attribute

The code sequence to get the value of an extension attribute is the same, i.e., does not depend on whether the attribute is a core attribute or an extension attribute:

value = u.get (“birth_year”); // accessing an extension attribute

Similarly, an exemplary code sequence to set the value of a core attribute is:

User u = session.load (2);
value=u.set (“address.zipcode”, 75025); // modifying a core attribute

and the same code sequence is used to set the value of an extension attribute:

value=u.set (“birth_year”, 2005); // modifying an extension attribute

Thus, in accordance with aspects described herein, at the user interface level, there is no need to differentiate between a core attribute and extension attribute. The commands entered by a user are the same for both a core attribute and an extension attribute.

Other features of a business object modeling system and method described herein provide a scripting interface that enables an enterprise to write business logic that works with both core and extension attributes. The scripting engine is a standard Javascript implementation in Java (Rhino). Some of the interfaces necessary to enable the scripting are

Interface to perform read, save and delete operations on entities,

Interface for predicate and query generation and

Interface to the get and set functions of the entities.

An exemplary script to obtain a list of users born after the year 2000 is as follows:

```
    var users = query (“from com.example.entities.User
    where birth_year > 2000”);
    for (var u in users) {
      for (var c in u.visited_countries) { // referencing user’s extension
                                  // attribute “visited_countries”
        print (u.name + ’ : ’ + c.region) //referencing user’s core
                                  // attribute “name” and countries’
                              // extension attribute“region”
      }
}
```

The query method referred in the script call the query processor to return the list if users satisfying the predicate. The access functions such as “u.visited_countries”, “u.name,” and “c.region” invoke the corresponding attribute type-independent get method described above.

Note that the scripting interface gives us a uniform interface to core and extension attributes. In other words, the user can write a simple script that will enable the user to query both core and extension attributes without the need to distinguish between the two or know which type of attribute, core or extension, the enterprise considers a particular attribute to be.

Another embodiment of a business object modeling system and method in accordance with aspects and features described herein provides an ability to perform rule-based evaluation of attributes of an entity. For example, an enterprise system can have some embedded business logic based on the enterprise entities' core attributes.

When an enterprise system is deployed, almost all the major entities (or concepts) also exist in some other enterprise data system. For example, the concept of user exists in a User Directory such as Microsoft Corporation's ACTIVE DIRECTORY product or some other LDAP-based product. The concept of bill of materials (BOM) exists in some supply chain data management system such as SAP™. When additional systems are deployed, the data requirements for deploying the new systems can be greatly reduced if those new systems provide efficient data integration with these existing enterprise data systems.

For example, the entity com.example.entities.User may have an attribute plan that is used by the enterprise system to create a monthly bill for its users. Consider a service provider that provides connectivity services (Dial-up, Internet, Wi-fi, etc.) to its clients. The provider installs an enterprise system that understands connectivity and is responsible for creating a monthly bill for its client. The provider has a list of predefined plans, where each plan has a rate per minute of connectivity for each region of the world. For example, a plan named “european plan” may cost $0.10 per minute for all connections from Europe and $0.50 per minute for the rest of the world. The system creates a monthly bill based on various parameters such as a user's connection duration, plan, etc. Thus, in the billing system each user has an attribute plan that is used to compute the cost incurred for the usage of connectivity services. The provider is interested in providing a cost-effective service, for example by assigning a european_plan for users from “Europe”, an asian_plan for users from “Asia,” etc. The provider may also be interested in providing an efficient service that allows users to change plan assignments when they move from one region to another. In addition, the provider may want to reduce the maintenance of users in two systems—an already existing user data store (Active Directory) and users in the billing system.

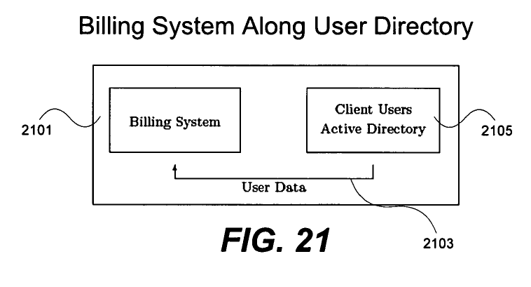

In accordance with a business object modeling system and method according to aspects and features herein, as shown in FIG. 21, billing system 2101 in such an enterprise can get user data 2103 from the enterprise's Active Directory 2105, and the value of the attribute plan for the enterprise's users can be computed using one or more rules.

Thus, instead of directly specifying a user's plan, the administrator can specify a set of rules that dictate the value for the attribute plan. Each attribute whose value can be rule-based has an associated object entity and relational table that can be used to evaluate the attribute.

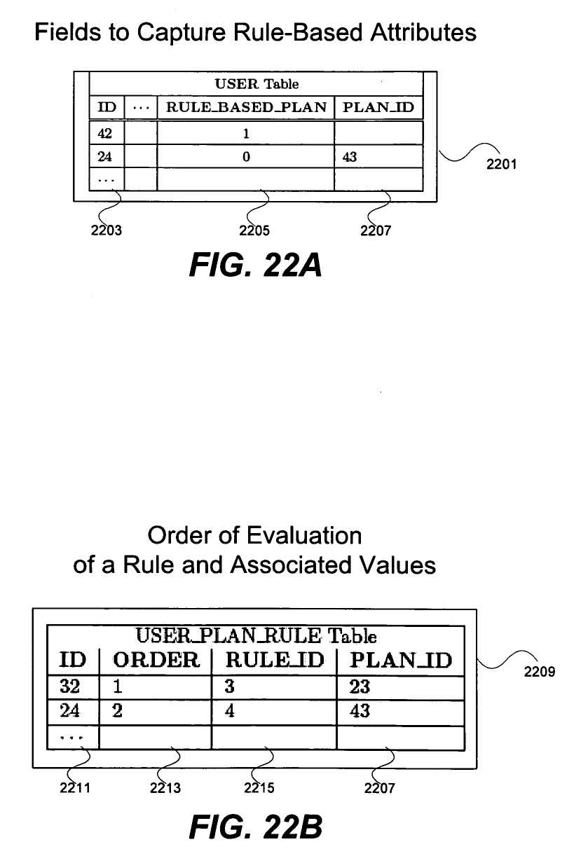

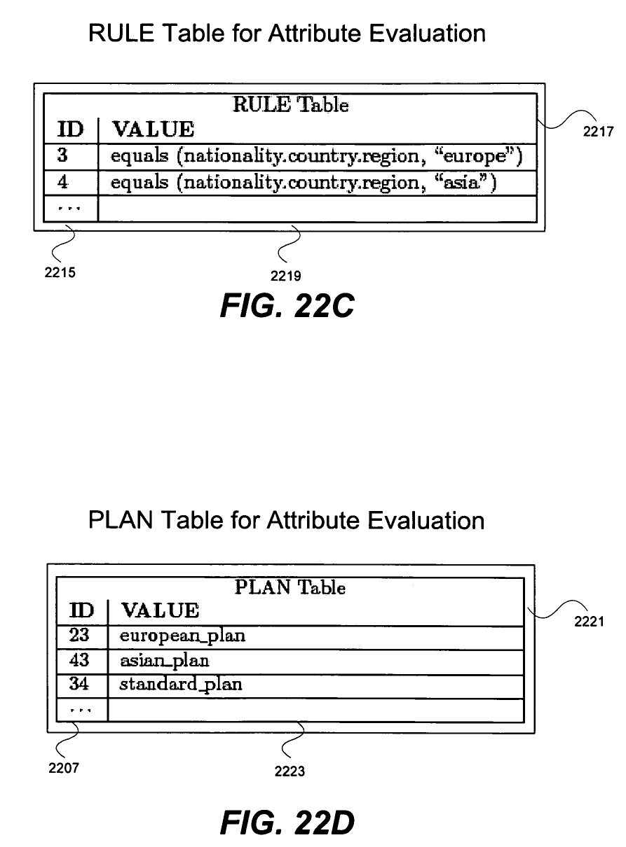

For example, if the plan attribute of com.example.entities.User is rule-based then the associated object entity is com.example.entities.UserPlanRule and the relational table is USER_PLAN_RULE 2209 shown in FIG. 22B. The table USER_PLAN_RULE 2209 has the following fields: ID 2211, which contains an identifier of the record; ORDER 2213, the order in which the rules are evaluated; RULE_ID 2215, a reference (foreign key) to the rule being evaluated; and PLAN_ID 2207, the value used when the rule evaluates to “true” for a particular user. Thus, for integrating the new enterprise system, the user information (username etc.) can be synchronized from an existing user directory like Active Directory with rules specified for the plan without having to modify the user information itself. This enables the life-cycle of the user records to be managed through an existing system.

The system implements the rule-based evaluation of attribute values for query processing and in memory evaluation.

The database schema includes addition of a flag to indicate whether the value of the core field is specific or should be evaluated using rules. Thus, as shown in FIG. 22A, for the USER with ID 24, the value of the user's plan attribute is given by the value in PLAN_ID field 2207, as indicated by the 0 value in the column RULE_BASE_PLAN 2205. For the USER with ID 42 the value of the attribute plan is computed using rules since the value in the field RULE_BASE_PLAN 2205 is 1. FIGS. 22B-22C show the rules that are evaluated to compute the value of the plan attribute. For example, as shown in FIG. 22B, the rules specified by the field RULE_ID 2215 in USER_PLAN_RULE table 2209 are evaluated in order (based on ORDER field 2213). For the user in question (in this case user with ID 42) the rules with ID 3 and 4 as given in the field RULE_ID 2215 are evaluated in order. If rule with ID 3 evaluates to true then the corresponding value in PLAN_ID 2207 that is a plan with ID 23 is assigned to the user in question otherwise the next rule is evaluated.

FIG. 22C specifies the rules in column VALUE 2219 and their corresponding ID 2215. As seen in FIG. 22C, ID 2215 shown in FIG. 22B correlates to a predicate expressed in VALUE field 2219 in RULE table 2217. For example, the value of the rule with ID 3 in the field ID 2215 corresponds to the predicate “equals (nationality.country.region, “europe”)” in VALUE field 2219, and the value of the rule with ID 4 corresponds to the predicate “equals (nationality.country.region, “asia”).” FIG. 22D specifies the plans in column VALUE 2223 and the corresponding ID 2207. Thus, as seen in FIG. 22D, the value of plan ID 43 in ID field 2207 in the PLAN table 2221 is “asian plan,” and user number 24 shown in FIG. 22A, whose plan ID number is 43, is covered by the enterprise under the enterprise's asian plan. The user number 42 whose plan ID number is unspecified is covered by one of the plans depending on which rule evaluates to “true.”

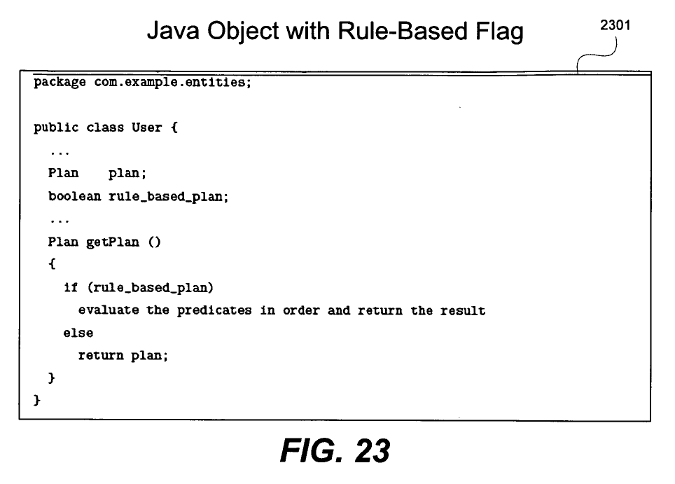

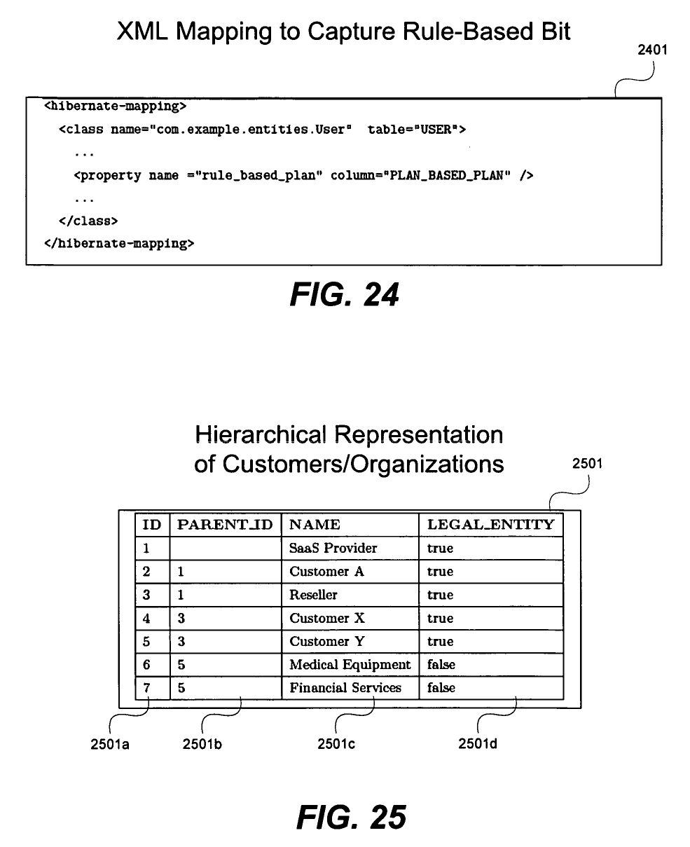

In the object-oriented environment, FIG. 23 shows the addition of a corresponding Boolean field in the definition 2301 of the entity com.examples.entities. User for evaluating whether a user is subject to a rule-based plan. FIG. 24 shows an exemplary mapping 2401 between the relational environment for rule-based evaluation described above and the object environment

Using the object-relational mapping between the object environment and the relational environment, evaluation of the plan attribute involves modifying the getter methods to check the Boolean field to return the value. For example, if the “rule_base_plan” flag is true, then the rules are evaluated in order to compute the value of the field.

For query processing relating to rule evaluation as discussed above, the generation of SQL from OQL by the query processor embeds the rules for the result set computation. For example, for the list of users with a plan attribute value of European_plan the predicate can be given by

equals (plan.name, “european_plan”)

The SQL query generated by Query Processor 1607 shown in FIG. 16 can be in the form:

```
select u.ID
from USER u
where (u.RULE_BASED_PLAN = 0 and
    exists (select 1
        from PLAN p
        where u.PLAN_ID = p.ID and
        p.NAME = “european_plan”))
    OR
        (u.RULE_BASED_PLAN = 1 and
        /* Expanding RULE_ID = 3 from USER_PLAN_RULE */
        /* equals (nationality.country.region, “europe”) */
        (exists (select 1
            from NATIONALITY n
            where n.ID = u.NATIONALITY_ID and
              exists (select 1
                from COUNTRY c
                    where n.COUNTRY_ID = c.ID and
                            exists (select 1
                from EXT_COUNTRY ec
                    where c.ID = ec.ID AND
                        ec.ATTR_ID-26 AND
                    ec.V_STR_0=“europe”)))
        AND
        /* The PLAN_ID corresponding to first rule from
        USER_PLAN_RULE is 23 */
        (select 1 from PLAN where ID = 23 and
        NAME = “european_plan))
OR
...
)
```

Another embodiment of a business object modeling system and method having one or more features described herein relates to a system that can be used to support Software-as-a-Service provisioning. The value proposition of a SaaS provider is two-fold. Use of an SaaS provider enables an organization to outsource the activities that are not part of its core competency, thus allowing it to concentrate on its core offerings. In addition, by using an SaaS provider, an organization is able to get a better quality of service since the provider's sole focus is the service, enabling it to innovate and invest in the focused area.

However, such outsourcing of services can induce inefficiencies in data management unless they are addressed. For example, an organization may have to manage two user management systems, or management of data may become a two step process—the organization has to instruct a representative of the provider, who then makes the necessary changes in the enterprise system. Another inefficiency stems from the inability to extend the model or add custom business logic. Thus, data management in an SaaS environment requires a flexible data model design. The system should allow customer specific extensions to the data model to enable modeling a customer specific objectives.

Aspects and features of a business object modeling system and method described herein can provide a mechanism that can allow a provider such as an SaaS provider to extend a standard data model and so meet the specific needs of a customer or reseller.

An enterprise system for a SaaS provider should enable creation of an environment that can replicate an in-house deployment of the service. Therefore, the enterprise system should provide an environment where a customer can create extensions to the model and add business logic. The environment thus created for the customer should be insulated from changes (e.g., extensions of the model and addition of business logic) enabled for another customer.

These two elements of an business object modeling system and method in accordance with aspects described here in can be enabled using two concepts: Hierarchical Namespace and Visibility.

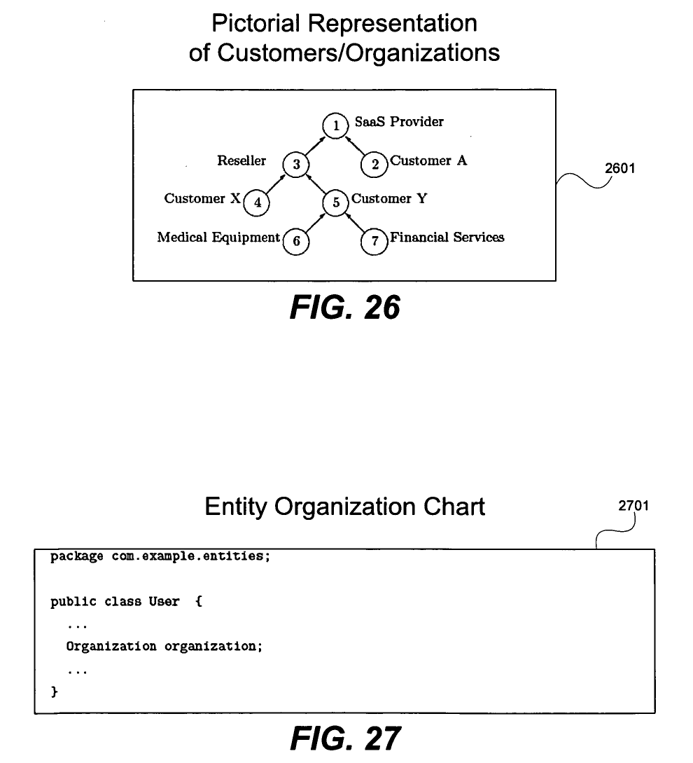

A business object modeling system and method having one or more features and aspects described herein can provides a hierarchical representation of data, that is, every entity can be associated with an organization tree. As shown in FIG. 25, data in data table 2501 can be shown wherein each record having a name 2601c in the organization's database has an associated ID 2501a. In addition, each record is shown as having a PARENT_ID 2501b. For example, as shown in FIG. 25, the record for “SaaS provider” is given ID number 1 and is shown as having no PARENT_ID; in contrast, the record for Customer A is given ID number 2 and is shown as having PARENT_ID number 1. Similarly the record for Medical Equipment is shown as having ID number 6 and PARENT_ID number 5. The hierarchical nature of the record ID numbers and PARENT_IDs is shown more clearly in schematic 2601 in FIG. 26.

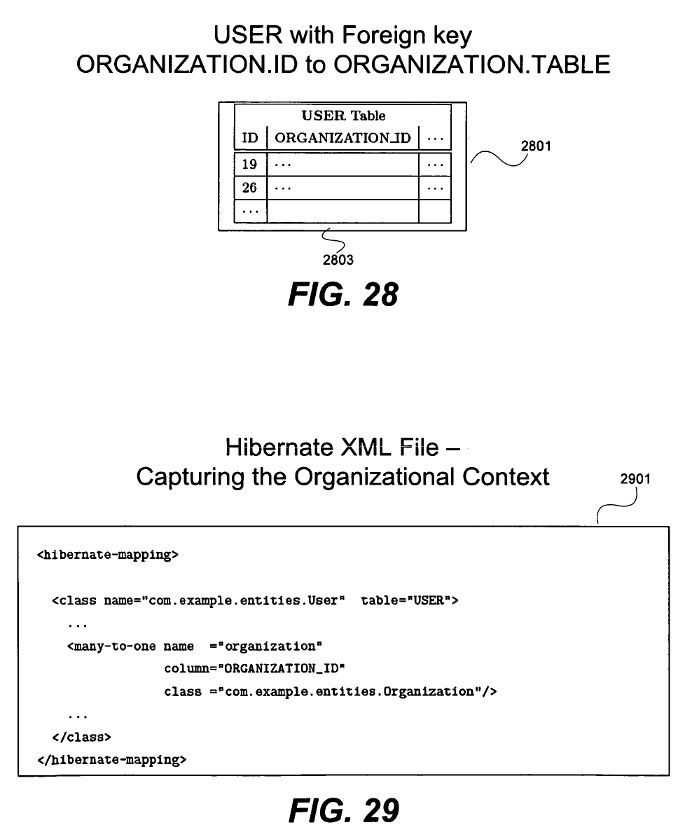

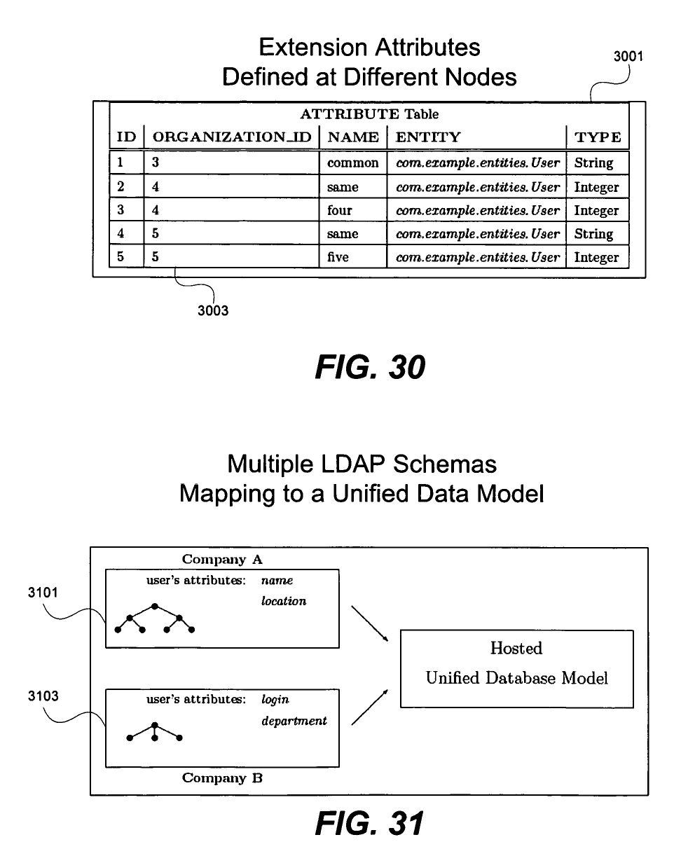

This hierarchical structure forms the basis for all other entities. Therefore, as shown in FIG. 27, the entity com.example.entities.User has an additional attribute (i.e., the code snippet “{Organization organization}”) that refers to an organization (or node) in the tree. As shown in FIG. 28, the USER table 2801 has an additional field 2803 ORGANIZATION_ID (a foreign key to the ORGANIZATION table), and FIG. 29 shows the mapping 2901 between the attribute organization of the class com.example.entities.User and the field ORGANIZATION_ID of the table ORGANIZATION. Similarly, an attribute object com.example.entities.Attribute has an attribute organization and the corresponding ATTRIBUTE table 3001 shown in FIG. 30 has a field ORGANIZATION_ID 3003.

A business object modeling system and method having features and aspects is described herein also defines the concept of visibility. All processing (through queries, etc.) has an organization context associated with it. There are two fundamental types of visibility, bottom-up and top down. Entities that are managed (e.g. users, computers) follow bottom-up visibility and entities that define how other entities are managed (e.g. configuration, service plans) follow top-down visibility.

For bottom-up visibility, the set of visible entities at a node comprises the set of entities that belong to the context node (the node where we are defining the visibility set) or to the subtree rooted at the context node. For example, if a query is executed in the context of node 3 (Reseller) as shown in FIG. 26, then the result set from that query is a subset of all the entities defined for 3—the context node—and the subtree i.e. 4, 5, 6, and 7. This can be alternatively specified using SQL as “select*from USER where ORGANIZATION_ID in (3, 4, 5, 6, 7).” For top down visibility, the set of visible entities at a node comprises the set of entities that belong to the context node in addition to the set of entities visible to the context's parent node. For example, if a query is executed in the context of node 5 (Customer Y) shown in FIG. 26, then the result set is a subset of all the entities defined for 5—the context node—and its parents (3 and 1).

The concepts of hierarchy and visibility implicitly provide data partitioning. Whenever any business process is run, a projection of the data is presented to the system. The projection is dictated by the visibility type of the entity. The entities that have “top down” visibility affect the entities that are defined only within their subtrees. The result is that an object such as com.example.entities.Attributes defines entity extensions that are valid only in the subtree where they are defined and can be referred in rules defined only in the subtree where they are defined. Top-down visibility of entities allows providers (SaaS providers or Resellers) to define services like connectivity plans and make them available to the bottom-up entities defined in the subtree. The concept of visibility, for example, as seen in the tree structure shown in FIG. 26, brings the concept of isolation between two customers such as Customer X and Customer Y shown in FIG. 26. A entity (instance of com.example.entities.Attribute or com.example.entities.Plan) that follows top-down visibility defined at node 2 (Customer A) is not visible to the subtree rooted at the node 3 (Reseller) and vice-versa. Therefore an administrator belonging to the organization “Customer A” can create, modify entities without effecting the organization “Reseller” and its subtree (or its managed customers). We will illustrate the concept of isolation with respect to com.example.entities.Attribute (hence extension attributes) in the discussion below.

In a SaaS environment, the system should enable localized configuration of the system by one customer without affecting another. Say, the Reseller (node 3) wants to capture an additional attribute (thus an extension attribute) named “common” for all its users. Therefore the Reseller can define an instance of com.example.entities.Attributes that corresponds to the record ID=1 in the ATTRIBUTE table 3001 shown in FIG. 30. Note that the ORGANIZATION_ID=3. Therefore all instances of com.example.entities.User defined at node 3 or its subtree will have an attributes “common” and any other instance of com.example.entities.User are not affected (that is, a user defined at node 2 does not have an attribute “common”). This provides an isolation between how the Reseller wants to configure the system and how Customer A (node 2) wants to configure the system.

The extension attributes of an entity are defined by the set of com.example.entities.Attributes visible at the context node. For example, an instance of com.example.entities.User defined at node 5 for Customer Y as shown in FIG. 26 has extension attributes defined by the subset of com.example.entities.Attributes in which organization is one of node 1 (SaaS Provider), node 3 (Reseller), or node 5 (Customer Y). FIG. 30 shows a possible scenario where an instance of the entity com.example.entities.User defined at nodes 5 or 6 or 7 will have the extension attributes

| Name | Type | Notes |
|---|---|---|
| common | String | Defined at organization Reseller/3 |
| Same | Integer | Defined at organization Customer Y/5 |
| Five | Integer | Defined at organization Customer Y/5 |

whereas an instance defined at 4 (Customer X) will have the extension attributes

| Name | Type | Notes |
|---|---|---|
| common | String | Defined at organization Reseller/3 |
| Same | String | Defined at organization Customer X/4 |
| Four | Integer | Defined at organization Customer X/4 |

As can be seen in this example, entities can be extended by two customers independent of each other. For example, the set of valid paths for com.example.entities.User defined at node 4 are different from the set of valid paths for com.example.entities. User defined at node 5:
a) The path “four” is valid for users defined at node 4 but not for users defined node 5, and the path “five” is valid at node 5 but not at node 4.
b) The path “same” is valid for users defined at both node 4 and node 5, but probably have completely different meaning, given one is an Integer and another is a String value.
c) The path “common:” is valid for users defined at both node 4 and node 5 and have the same meaning/significance, but is an invalid path for users defined at node 2.
   Thus, each customer may extend its entities using extension attributes without affecting other customers.

For rule-based evaluation of attributes, the order of evaluation is up the hierarchy until the root of the organizational tree is reached, or a rule is found. For example, for a rule-based attribute plan for entity com.example.entities.User defined at node 5, the rules specified at node 5 are evaluated, and then those at node 3 and then those at node 1. This enables the two organizations Customer X and Customer Y to have two completely different set of rules to evaluate a rule-based attribute.

We shall illustrate the process of rule-based evaluation in a hierarchical setting using an example. Consider the following rules to be defined at the reseller node, node 3:

| Organization | # | Rule or Predicate | Value |
|---|---|---|---|
| 3 | 1 | equals (nationality.country.region, | european plan |
| | | “europe”) | |
| 3 | 2 | equals (nationality.country.region, | asian plan |
| | | “asia”) | |
| 3 | 3 | True | standard plan |

Customer X can override the rules by defining a new set of rules for Customer X, node 4:

| Organization | # | Rule or Predicate | Value |
|---|---|---|---|
| 4 | 1 | or (equals (four, 42), | european plan |
| | | equals (nationality.country.region, | |
| | | “europe”)) | |
| 4 | 2 | True | standard plan |

In the context of the assignment of “plans” as described above, the resulting evaluation of the rules for users defined at 4 or its subtree is

if (or (equals (four, 42),
equals (nationality.country.region, “europe”))) assign “european_plan”
else
assign “standard_plan”

The organization/client Customer X defined a rule that referred to an model extension applicable to its subtree—four, and modified the logic for computing the value of plan attribute completely. Customer Y can partially override the rules by defining a new set of rules at node 5:

| Organization | # | Rule or Predicate | Value |
|---|---|---|---|
| 5 | 1 | or (equals (five, 42), | european plan |
| | | equals (nationality.country.region, | |
| | | “europe”)) | |

The resulting evaluation of the rules for users defined at 5 or its subtree is

```
if (or (equals (five, 42),
    equals (nationality. country .region, “europe”)))
    assign “european_plan”
else if (equals (nationality.country.region, “europe”))
assign “european_plan”
else if (equals (nationality.country.region, “asia”)) assign “asian_plan”
else
    assign “standard_plan”
```

In conclusion, a client of the SaaS provider (an organization) can define their own rules for rule-based attributes without affecting the rules of another customer. In addition, a customer can use all of the entity attribute extensions that are visible to it from a top-down perspective.

Other aspects of a business object modeling system and method described herein can relate to the way in which an LDAP-based product like Active Directory, openLDAP, iPlanet, etc. plays a central role in user management for a SaaS provider's typical customers. IT (and non-IT) administrators want to manage all aspects of user management from their standard user repository like Active Directory or LDAP. Aspects of a business object modeling system and method described herein can assist such administrators to meet these goals.

In any SaaS system, user management is one of the critical functions provided by the platform. User life cycle management is necessary for enabling the services provided by a provider. In addition, the user identities are stored in a data repository, e.g., a relational database management system (RDBMS). Synchronizing user identities from a customer's LDAP to the platform is a seamless way to manage the lifecycle of a user. Thus, a customer administrator creates, updates, or deletes a user in their corporate LDAP and at the next sync cycle the action is reflected in provider's repository. The synchronization can be provided using bulk load processes or through the use of virtual directory technology.

An embodiment of a business object modeling system and method described herein can provide a mechanism to allow an enterprise to map multiple LDAP schemas, where each customer may have a different schema, into a unified relational data model.

A customer can extend any business object (User, Location, Currency etc) in the system to represent an attribute from their corporate LDAP. The value of that business object can be stored in a non-normalized data table. In this way, a customer's user attributes can be stored in the enterprise's data system.

The organizational information relating to a customer can be stored in a hierarchical model. As described above, a node can be created for each customer and the particular customer's LDAP tree is copied as a subtree branching from that customer's node. Model extensions can be anchored on the hierarchical organizational tree. For example, extension of the user model with an attribute location for customer A is defined and anchored at the node defined for customer A and the extension of that attribute is only applicable to the nodes in the subtree extending from that node in a manner similar to that shown in FIG. 31. When an administrator from customer A logs into the system, the session is anchored to the customer A's node 3101, hence the extensions defined for a different customer are not applicable and not accessible.

Similarly, when an administrator from customer B logs into the system, she can see only customer B's node 3103 and any subtrees extending from that node. Thus, customer A and customer B can be kept separate and independent.

The synchronization of multiple directories can allow an enterprise to provide more useful services to its customers. For example, an SaaS provider may need to include the option of user management as a function to be provided by the enterprise system to its customers. For example, in one embodiment of the concept of user management, the value of a plan attribute for a user (for example, a value of a connectivity plan) is relevant to the provider. The instances of users and their life-cycle management can be accomplished through Active Directory (or any other user repository) synchronization process. In a specific embodiment, if the user does not have the attribute plan in Active Directory, the synchronization process cannot provide a value of the plan attribute necessary for the provider to service the client. Hence, the enterprise system has to provide a workflow to manage attribute assignments such as plan that are relevant to the provider.

Aspects and features of a business object modeling system and method described herein can permit the value of the attribute, for example, the plan attribute, to be dictated by some rule in the corporation. The rule may be based on the department or level in the management ladder or a combination of some attributes for that person that already exist and are actively managed in Active Directory (or user repository). In this way the customer does not need to extend their own Active Directory (or user repository) to capture/manage provider-required attributes.

As noted earlier, in accordance with aspects described herein, a customer can extend entities with attributes that are relevant only within their corporation. The assignment of values for a provider's attributes (like plan) can be accomplished by defining one or more rules that can determine the value. For example, a customer wants to assign plans based on two attributes that are stored in their LDAP—(department and years of service). The customer can extend user based attributes by defining two new attributes (the values for these attributes are populated during LDAP synchronization):

String department;

Integer yearsOfService.

Now she can define rules for plan assignment:

| | |
|---|---|
| if (department = Sales and yearsOf Service > 10) | plan = Platinum |
| if (department = Dev and yearsOf Service > 10) | plan = Gold |
| if (department = Sales and yearsOf Service > 5) | plan = Gold |
| ... | |

The result is a seamless management of an enterprise's user population vis-à-vis a service provider without having to make any changes to the customer's user management system. When a user moves from dev to sales or completes ten years of service she is automatically assigned a higher plan. This seamless management can be provided by at least the following components of a business object modeling system and method in accordance with aspects herein:

LDAP integration,

extension of user attributes in the SaaS system,

assignment of attribute values using rules.

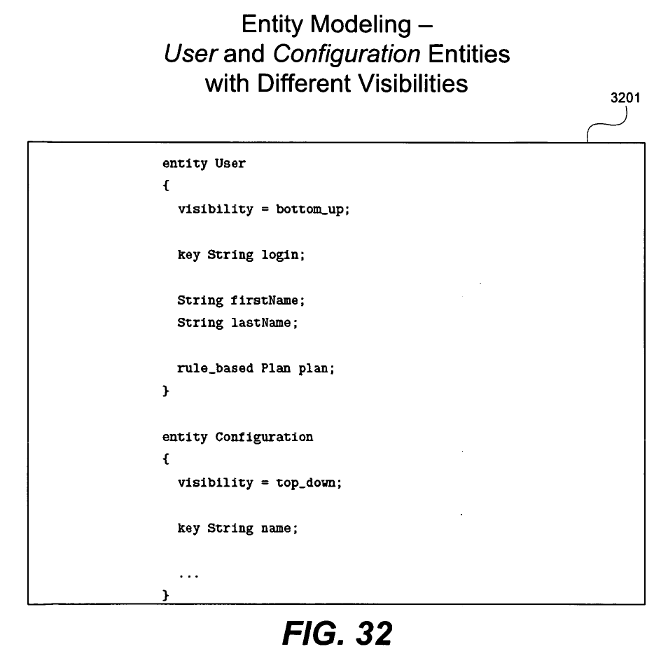

When using various aspects described in this document, it may be desirable to have various tables and the necessary mappings specified. The structure of the tables (table names, field names, relationships) dictate the output SQL from the query processor. Therefore, instead of a developer making sure that all the mappings are correct, a compiler can be written whose input is a business object description. Based on the input definitions, this compiler can generate all necessary tables, mapping files and POJO descriptions for use in the methods described herein. FIG. 32 depicts an example input to such a compiler.

It should be noted that aspects of a business object modeling method and system described herein can be accomplished by executing one or more sequences of one or more computer-readable instructions read into a memory of one or more computers from volatile or non-volatile computer-readable media capable of storing and/or transferring computer programs or computer-readable instructions for execution by one or more computers. Volatile computer readable media that can be used can include a compact disk, hard disk, floppy disk, tape, magneto-optical disk, PROM (EPROM, EEPROM, flash EPROM), DRAM, SRAM, SDRAM, or any other magnetic medium; punch card, paper tape, or any other physical medium. Non-volatile media can include a memory such as a dynamic memory in a computer. In addition, computer readable media that can be used to store and/or transmit instructions for carrying out methods described herein can include non-physical media such as an electromagnetic carrier wave, acoustic wave, or light wave such as those generated during radio wave and infrared data communications.

Although particular embodiments, aspects, and features have been described and illustrated, it should be noted that the invention described herein is not limited to only those embodiments, aspects, and features. It should be readily appreciated that modifications may be made by persons skilled in the art, and the present application contemplates any and all modifications within the spirit and scope of the underlying invention described and claimed herein. Such embodiments are also contemplated to be within the scope and spirit of the present disclosure.

I claim:

1. A computer-implemented method for extending an object-relational mapping system to facilitate extending an entity with an extension attribute, the extension attribute depending on a value of a reference attribute of the entity, comprising:
providing an attribute definition table, the attribute definition table including an identifier of an entity type being extended, an identifier of the reference attribute associated with the extension attribute, and an identifier of a type of the extension attribute, the extension attribute type including one of an integer type, a string type, an entity type, and a composite type;
providing an entity data table, the entity data table including an object identifier of an object, the object being an instance of the entity type being extended, and further including data of a core attribute of the object; and
providing an extension attribute data table, the extension attribute data table including the object identifier and an identifier of the extension attribute, the extension attribute data table further including information of a value of the extension attribute;
wherein the entity is extended by the value of the extension attributes.

2. The method according to claim 1, wherein the reference attribute of the entity is the entity's organization.

3. The method according to claim 1, further comprising providing an integer value of the extension attribute in the extension attribute table if the extension attribute is of integer type.

4. The method according to claim 1, further comprising providing a string value of the extension attribute in the extension attribute table if the extension attribute is of string type.

5. The method according to claim 1, further comprising providing at least one further attribute identifier if the extension attribute is of entity type, the at least one further attribute being an attribute of an entity comprising a value of the entity type extension attribute and the at least one further attribute identifier being set forth being set forth in a second data table;
wherein a value of the extension attribute includes a value associated with the at least one further attribute in the second data table.

6. A computer-implemented method for implementing an object-relational mapping tool to facilitate assignment of a value to an attribute of an entity, comprising:
providing a rule for computing the value of the attribute, the rule depending on a value of a reference attribute of the entity;
providing a bit associated with the attribute, the bit indicating whether the value of the attribute is explicitly assigned or is assigned using the rule;
providing a table to store the value of the attribute if the value of the attribute is explicitly assigned; and
providing a table to store information of the rule and the corresponding value of the attribute if the value of the attribute is computed using the rule.

7. The method according to claim 6, wherein the reference attribute is an organization of the entity.

8. A computer-implemented method for getting a value of an attribute associated with an entity in a system, comprising:
receiving a query for the value of the attribute, the query not specifying whether the attribute is a core attribute or an extension attribute of the entity;
inspecting an attribute path for the queried attribute;
determining whether the attribute path references a core attribute or references an extension attribute;
calling a command to get the value of the attribute, the called command being a first command if the attribute path references a core attribute and being a second command if the attribute path references an extension attribute; and
getting the value of the attribute in accordance with the called command.

9. A computer-implemented method for setting a value of an attribute of an entity in a system, comprising:
receiving a request to set a value of a specified attribute of the entity, the request not specifying whether the specified attribute is a core attribute or an extension attribute;
inspecting an attribute path for the specified attribute;
determining whether the attribute path references a core attribute or references an extension attribute;
calling a command to set the value of the specified attribute, the called command being a first command if the attribute path references a core attribute and being a second command if the attribute path references an extension attribute; and
setting the value of the specified attribute in accordance with the called command.

10. A computer-implemented method for processing a query for entities in a system whose attributes satisfy at least one specified condition, the system comprising entities having both core attributes and extension attributes, a value of at least one of the core attributes being maintained separately from a value of at least one of the extension attributes, the method comprising:
receiving a first query for entities in the system whose attributes satisfy the at least one specified condition, the first query being in a first form associated with a first manner of organizing data, the first query not specifying whether the referenced attribute in the first query is a core attribute or an extension attribute; and
converting the first query into a second query in a second form associated with a second manner of organizing data, the second query containing information of a relational data structure associated with the referenced attribute, the relational data structure being a first structure if the referenced attribute is a core attribute and being a second structure if the referenced attribute is an extension attribute;
wherein an answer to the first query is returned in accordance with information returned from the second query, the information returned from the second query being in accordance with the relational data structure in the second query.

11. The method of processing a query according to claim 10, wherein the first query references a core attribute of an entity in an object-centric interface and further wherein the information of the relational data structure includes information of at least one path associated with the referenced core attribute.

12. The method of processing a query according to claim 10, wherein the first query references an extension attribute of an entity in an object centric interface, and further wherein the information of the relational data structure includes information of at least one path associated with the referenced extension attribute.

13. The method of processing a query according to claim 10, wherein the first query references a core attribute of an entity in an object-centric interface whose value is decided based on a rule, and further wherein the information of the relational data structure includes information of at least one path associated with the referenced core attribute and the rule.

14. The method of processing a query according to claim 10, wherein the first query references both a core attribute and an extension attribute of an entity in the system, and further wherein the relational data structure in the second query includes information of both the core attribute and the extension attribute.

15. The method of processing a query according to claim 10, wherein the first query is in object-oriented form and comprises at least one operator and at least one predicate.

16. The method of processing a query according to claim 10, wherein the second query further includes information of an attribute path associated with the referenced attribute, the method further comprising;
determining whether the attribute path references a core attribute or references an extension attribute;
calling a command in the second query to get the value of the referenced attribute, the called command being a first command if the attribute path references a core attribute and being a second command if the attribute path references an extension attribute; and
getting the value of the queried attribute in accordance with the called command.

17. The method of processing a query according to claim 10, wherein the value of the referenced attribute is based on a rule to be applied to a second attribute, the rule not depending on whether the second attribute is a core attribute or an extension attribute, wherein the second query includes information of the rule, and further wherein the method further comprises evaluating the rule and returning the value of the queried attribute based on the evaluation of the rule.

18. A computer-implemented method of querying a system to fetch a value of an attribute of an entity in the system, comprising:
identifying a first attribute whose value is to be fetched, the identification not specifying whether the first attribute is a core attribute or an extension attribute;
determining a rule for a value of the first attribute based on a value of a second attribute, the rule not depending on whether the second attribute is a core attribute or an extension attribute;
inspecting a path associated with the first attribute, the path including a first data table associated with the first attribute;
inspecting the path associated with the second attribute to determine a value of the second attribute;
evaluating the rule; and
fetching the value of the first attribute in accordance with the value of the second attribute and the rule.

19. The method for getting a value of an attribute according to claim 18, wherein the path associated with the second attribute includes a second data table associated with the second attribute, the value of the second attribute being determined from an entry in the second data table.

20. The method of getting a value of an attribute according to claim 18, wherein the value of the second attribute is determined by a predicate comprising an operator and a filtering condition.

21. A computer program product including a computer storage medium, the computer storage medium comprising one of volatile media and non-volatile media, and a computer program code mechanism embedded in the computer storage medium for facilitating the retrieval of a value for an attribute of an entity, comprising:
a computer code device configured to receive a first query for a value of a first attribute, the query being in a first form associated with a first manner of organizing data in the database, the first query further not specifying whether the first attribute is a core attribute or an extension attribute;
a computer code device configured to convert the first query into a second query in a second form associated with a second manner of organizing data in the database, the second query containing information of a relational data structure associated with the first attribute, the relational data structure being a first structure if the first attribute is a core attribute and being a second structure if the first attribute is an extension attribute;
a computer code device configured to inspect an attribute path associated with the first attribute;
a computer code device configured to call a command to get the value of the first attribute, the computer code device being further configured to call a first command if the attribute path references a core attribute and to call a second command if the attribute path references an extension attribute; and
a computer code device configured to fetch the value of the first attribute in accordance with the called command;
wherein the value of the first attribute is returned as a result of the first query.

22. The computer program product according to claim 21, further comprising:
a computer code device configured to get the value of the first attribute based on a rule applicable to a second attribute, the rule not depending on whether any one of the first and second attributes is a core attribute or an extension attribute;
a computer code device configured to evaluate the rule; and
a computer code device configured to get the value of the first attribute in accordance with the called command and the rule;
wherein the value of the first attribute is returned as a result of the first query.

23. A computer program product including a computer storage medium, the computer storage medium comprising one of volatile media and non-volatile media, and a computer program code mechanism embedded in the computer storage medium for facilitating the processing of a query for information of an attribute of an entity in a database, the database comprising entities having both core attributes and extension attributes, a value of at least one of the core attributes being maintained separately from a value of at least one of the extension attributes, comprising:
a computer code device configured to receive a first query for information of an attribute in a first form associated with a first manner of organizing data in the database, the first query not specifying whether the queried attribute is a core attribute or an extension attribute;
a computer code device configured to convert the first query into a second query in a second form associated with a second manner of organizing data in the database, the second query containing information of a relational data structure associated with the queried attribute, the data structure being a first data structure if the queried attribute is a core attribute and being a second data structure if the queried attribute is an extension attribute; and
a computer code device configured to fetch a value of the queried attribute in accordance with one of the first and second data structures;
wherein an answer to the first query is returned based on the information associated with the relational data structure in by the second query.

24. A computer program product including a computer storage medium, the computer storage medium comprising one of volatile media and non-volatile media, and a computer program code mechanism embedded in the computer storage medium for facilitating the processing of a query for information of an attribute of an entity in a database, the database comprising entities having both core attributes and extension attributes, a value of at least one of the core attributes being maintained separately from a value of at least one of the extension attributes, comprising:
a computer code device configured to receive a first query for information of a first attribute in a first form associated with a first manner of organizing data in the database, the first query not specifying whether the first attribute is a core attribute or an extension attribute, a value of the first attribute being based on a value of a second attribute in accordance with a rule, the rule not depending on whether the second attribute is a core attribute or an extension attribute;
a computer code device configured to convert the first query into a second query in a second form associated with a second manner of organizing data in the database, the second query containing information of a relational data structure associated with the queried attribute, the data structure being a first data structure if the first attribute is a core attribute and being a second data structure if the first attribute is an extension attribute;
a computer code device configured to evaluate the rule; and
a computer code device configured to fetch a value of the first attribute in accordance with one of the first and second data structures and the rule;
wherein an answer to the first query is returned based on the information associated with the relational data structure in the second query and the rule.
